(19) United States
(12) Patent Application Publication
(10) Pub. No.: US 2015/0269360 A1
(43) Pub. Date: Sep. 24, 2015

(54) CONTROL METHOD AND SYSTEM

(71) Applicant: FUJITSU LIMITED, Kawasaki-shi (JP)

(72) Inventor: Yasuhiko ABE, Niiza (JP)

(21) Appl. No.: 14/643,624

(22) Filed: Mar. 10, 2015

(30) Foreign Application Priority Data
Mar. 18, 2014 (JP) 2014-054750

(51) Int. Cl. G06F 21/10; G06F 21/78; G06F 21/62

(52) U.S. Cl. CPC G06F 21/10; G06F 21/62; G06F 21/78; G06F 2221/0704

(57) ABSTRACT

A control method executed includes acquiring, from a storage medium, content data and first encrypted information encrypted by a first unique key associated with the first information processing device, the first encrypted information including a first value for controlling a use right of the content data, obtaining the first value by decrypting the first encrypted information with the first unique key, enabling the first information processing device to use the content data when the first value is identified with a second value allocated to the first information processing device, generating second encrypted information by encrypting a third value with a second unique key that is associated with the second information processing device, the third value being for moving the use right from the first information processing device to the second information processing device, and updating the first encrypted information in the storage medium with the second encrypted information.

### CROSS-REFERENCE TO RELATED APPLICATION

This application is based upon and claims the benefit of priority of the prior Japanese Patent Application No. 2014-054750, filed on Mar. 18, 2014, the entire contents of which are incorporated herein by reference.

### FIELD

The embodiments discussed herein are related to control of moving content data between devices.

### BACKGROUND

There has been put to practical use a DRM technique to protect copyrighted data (hereinafter referred to as contents) such as music, videos, images, electronic books, programs and text data, for example. Note that DRM stands for Digital Rights Management. As an example of DRM, device binding is a method for giving the use right of a content to only one device and exclusively allowing (binding) the device to use the content.

For example, there are devices adopting the device binding as a method for recording a content of digital terrestrial broadcasting (full-segment). For example, many mobile devices adopt the device binding. When such a device adopting the device binding stores a content received through digital terrestrial broadcasting in a hard disk connected to the device, the content stored is bound to the device. In this case, the stored content may be reproduced by the device which has received the digital terrestrial broadcasting, but may not be reproduced by another device even if the other device is connected to the hard disk and tries to reproduce the content.

In this regard, there has been known a technique capable of protecting the copyright of information recorded in a recording medium without increasing manufacturing cost of the recording medium. Also, there has been known a technique capable of appropriate and stronger copyright protection. There has been known a technique in which even after a file is moved to another recording medium with format conversion, the file can be restored in an original recording medium without signal degradation. There has been known a technique capable of blocking leakage of a decryption key for an encrypted content to the outside, copying of the content, and the like. There has been known a technique capable of appropriately moving a content with a license bound to a terminal to another terminal in consideration of a change in the coverage of the license. There has been known a technique to improve convenience for users while reducing unfair use of a content. There has been known a technique that does not allow an unauthorized reproduction device to reproduce a content but only allows an authorized reproduction device to properly reproduce the content. These techniques are disclosed in Japanese Laid-open Patent Publications Nos. 10-283270, 2002-260326, 2007-242231, 11-352881, 2008-124649, and 2007-174682, International Publication Pamphlet No. WO 2005/103907, and the like, for example.

### SUMMARY

According to an aspect of the invention, a control method executed by a processor included in a first information processing device, the control method includes acquiring, from a storage medium, content data and first encrypted information encrypted by a first unique key associated with the first information processing device, the first encrypted information including a first value for controlling a use right of the content data, obtaining the first value by decrypting the first encrypted information with the first unique key, enabling the first information processing device to use the content data when the first value is identified with a second value allocated to the first information processing device, generating second encrypted information by encrypting a third value with a second unique key that is associated with the second information processing device, the third value being for moving the use right from the first information processing device to the second information processing device, and updating the first encrypted information in the storage medium with the second encrypted information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A, 1B, and 1C are diagrams illustrating binding of a content to information processing devices and transfer of the use right of the content according to one embodiment;

FIG. 2 is a diagram illustrating a functional block configuration of an information processing device according to some embodiments;

FIG. 3 is a diagram illustrating device information according to some embodiments;

FIG. 4 is a diagram illustrating destination management information according to a first embodiment;

FIG. 5 is a flowchart illustrating setting processing of an information processing device according to the first embodiment;

FIG. 6 is a diagram illustrating a content according to the first embodiment;

FIG. 7 is a flowchart illustrating processing of recording the content according to the first embodiment;

FIG. 8 is a flowchart illustrating use right transfer processing executed by a source information processing device according to the first embodiment;

FIG. 9 is a flowchart illustrating use right transfer processing executed by a destination information processing device according to the first embodiment;

FIG. 10 is a flowchart illustrating content moving processing to the destination information processing device according to the first embodiment;

FIG. 11 is a diagram illustrating some states of the information processing device according to the first embodiment;

FIGS. 12A, 12B, 12C, and 12D are diagrams illustrating some contents according to the embodiment;

FIG. 13 is a diagram illustrating source management information according to a second embodiment;

FIG. 14 is a flowchart illustrating setting processing of an information processing device according to the second embodiment;

FIGS. 15A and 15B are flowcharts illustrating use right transfer processing executed by a source information processing device according to the second embodiment;

FIG. 16 is a flowchart illustrating use right transfer processing executed by a destination information processing device according to the second embodiment;

FIG. 17 is a flowchart illustrating an operation flow of content moving processing according to the second embodiment;

FIG. 18 is a flowchart illustrating an operation flow of use right source transfer processing according to the second embodiment;

FIGS. 19A and 19B are flowcharts illustrating an operation flow of use right destination transfer processing according to the second embodiment;

FIGS. 20A and 20B are diagrams illustrating some states of the information processing device according to the second embodiment; and

FIG. 21 is a diagram illustrating a hardware configuration of a computer to realize the information processing device according to one embodiment.

### DESCRIPTION OF EMBODIMENTS

However, in device binding, since only one device is exclusively allowed use to a content, for example, there has been a situation where a user inevitably gives up the use of the content bound to the device when the user stops using the device. Therefore, there is desired a technique to transfer the use right of a content to another device while limiting the use of the content to only one device. It is an object according to one aspect of the present disclosure to provide a technique capable of exclusively allowing only one device to use a content even when the use right of the content is transferred to another device.

Hereinafter, with reference to the drawings, some embodiments are described in detail. Note that, throughout the drawings, corresponding elements are denoted by the same reference numerals.

As described above, in device binding, only one device is exclusively allowed to use a content, for example. Therefore, there has been a situation where a user inevitably gives up the use of the content bound to the device when the user stops using the device. Particularly, in recent years, cell-phones, smartphones and the like, for example, are frequently replaced with new models. This leads to a demand for a technique capable of transferring the use right of a content to another device while protecting the copyright of the content.

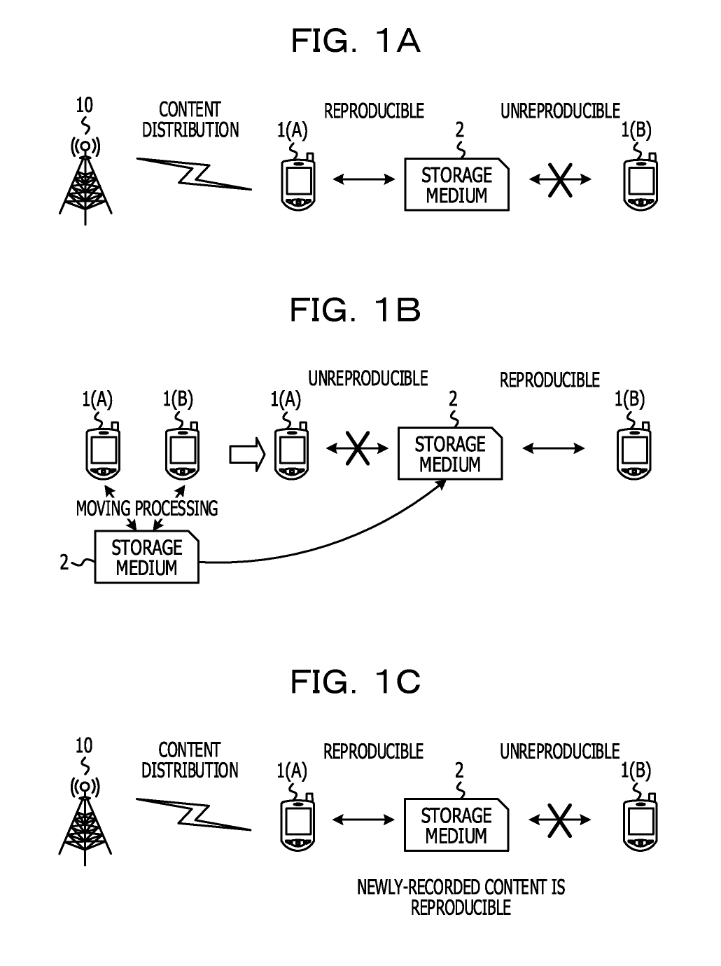

FIGS. 1A, 1B, and 1C are diagrams illustrating binding of a content to information processing devices 1 and transfer of the use right of the content according to one embodiment. Note that each of the information processing devices 1 may be a device having a function to use a content, such as a cell-phone, smartphone, tablet terminal, personal computer (PC), notebook PC and recorder, for example. The information processing device 1 (A) records a content distributed from a distribution device 10 in a storage medium 2 such as a SD memory card (Secure Digital memory card), for example, which is connected to the information processing device 1 (A) (FIG. 1A). During this storage of the content, the content to be recorded in the storage medium 2 are bound to the information processing device 1 (A) that is a content receiver, for example. For this reason, even if the storage medium 2 is connected to the information processing device 1 (B) in an attempt to reproduce the content by the information processing device 1 (B), the information processing device 1 (B) may not reproduce the content. For example, it is assumed that, in such a situation, the information processing device 1 (A) goes out of order due to some trouble or a user no longer uses the information processing device 1 (A) because of a model change or the like. In this case, since the content recorded in the storage medium 2 may not be used by any other devices but the information processing device 1 (A), there has been a situation that the user gives up using the content.

Therefore, in some embodiments, processing is performed to move the content bound to the information processing device 1 (A) to the information processing device 1 (B) (FIG. 1B). As a result of the moving processing, the content stored in the storage medium 2 are bound to the information processing device 1 (B). Thus, even if the storage medium 2 is connected to the information processing device 1 (A) in an attempt to reproduce the content, the information processing device 1 (A) may not reproduce the content. On the other hand, when the storage medium 2 is connected to the information processing device 1 (B) in an attempt to reproduce the content, the content may be reproduced since the content is bound to the information processing device 1 (B). Therefore, according to the embodiment, the use right of the content may be transferred while protecting the copyright of the content.

It is also assumed, for example, that after the use right of the content is transferred to the information processing device 1 (B), the information processing device 1 (A) records again the content distributed from the distribution device 10 in the storage medium 2 (FIG. 1C). In this case, according to some embodiments, the newly recorded content is bound to the information processing device 1 (A) and thus may not be reproduced by the information processing device 1 (B). Therefore, the information processing device 1 (A) may be reused after execution of the moving processing of the use right of the content.

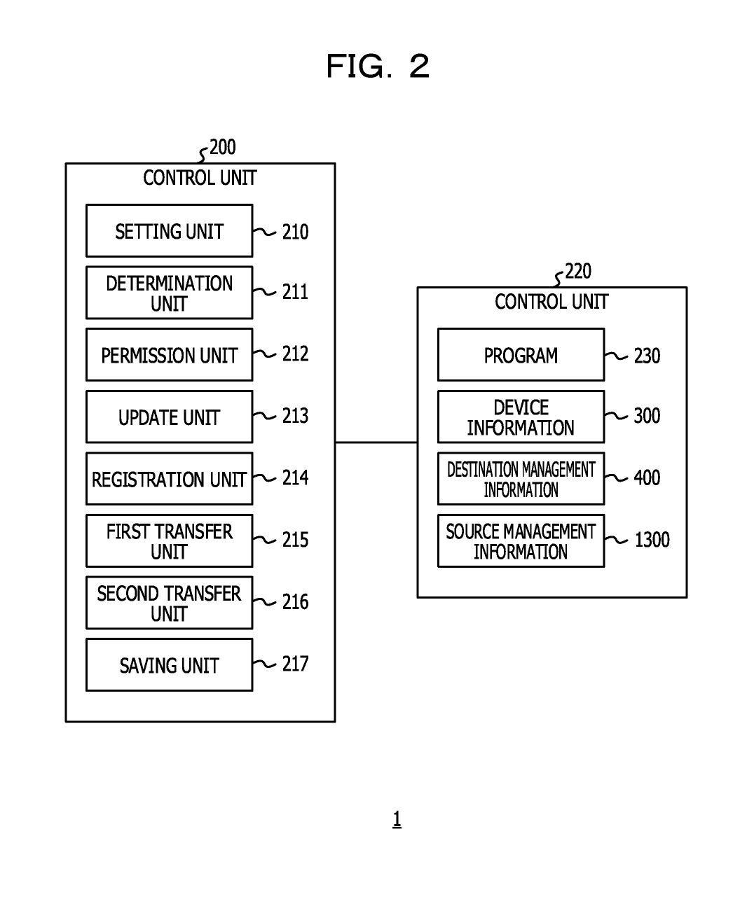

FIG. 2 is a diagram illustrating a functional block configuration of the information processing device 1 according to some embodiments. The information processing device 1 includes a control unit 200 and a storage unit 220, for example. The control unit 200 may include functional units such as a setting unit 210, a determination unit 211, a permission unit 212, an update unit 213, a registration unit 214, a first transfer unit 215, a second transfer unit 216 and a saving unit 217, for example. The storage unit 220 in the information processing device 1 may store information such as a program 230, device information 300, destination management information 400 and source management information 1300, for example. The storage unit 220 in the information processing device 1 may also store a content 600 to be described later. The control unit 200 in the information processing device 1 functions as the functional units such as the setting unit 210, the determination unit 211, the permission unit 212, the update unit 213, the registration unit 214, the first transfer unit 215, the second transfer unit 216 and the saving unit 217, for example, by reading and executing the program 230. These functional units and the information stored in the storage unit 220 are described in detail later.

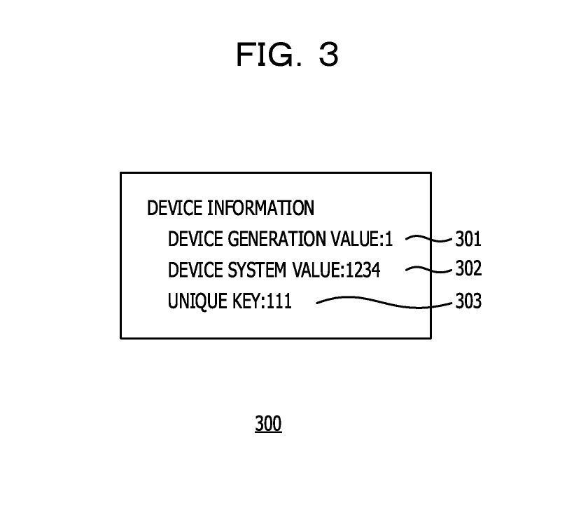

FIG. 3 is a diagram illustrating the device information 300 according to some embodiments. The device information 300 includes a device generation value 301, a device system value 302 and a unique key 303. The device generation value 301 is information to be updated to a value different from a value that has been previously set as the device generation value 301 of the information processing device 1, every time the use right transfer processing is executed, after an initial value is set in the information processing device 1 at a production plant, for example. In other words, the device generation value 301 is updated so as not to be set to the same value. Note that, in the following first and second embodiments, the device generation value 301 is a number within the range of 1 to 998, which is set to 1 as the initial value at the production plant and is then increased by 1 every time the use right transfer processing is executed. However, the embodiments are not limited thereto. For example, the device generation value 301 may be a value obtained by subtracting 1 from an initial value: 1000 every time the use right transfer processing is executed. In other words, the device generation value 301 may be a value changing in one direction, continuously increasing or decreasing, for example. Alternatively, the device generation value 301 may be a value that is converted by a predetermined algorithm so as not to be the same value, every time the use right transfer processing is executed, from an initial value expressed using alphabet and the like. The device system value 302 is a value that is set to a common value among devices within a group permitted to transfer the use right of a content, for example. The device system value 302 may be an arbitrary value, for example. The unique key 303 may be an encryption key generated based on unique information uniquely allocated to each of the information processing devices 1, for example. The unique key 303 is an encryption key unique to each of the information processing devices 1. The unique key 303 is preferably a value of 128 bits or more from a security perspective, for example. Note that there are no limitations on a form of storing the device generation value 301, the device system value 302 and the unique key 303, which are stored as the device information 300 described above. As illustrated in FIG. 3, for example, the device generation value 301, the device system value 302 and the unique key 303 may be collectively stored as one piece of data in the storage unit 220. Alternatively, the device generation value 301, the device system value 302 and the unique key 303 may be individually stored in the storage unit 220.

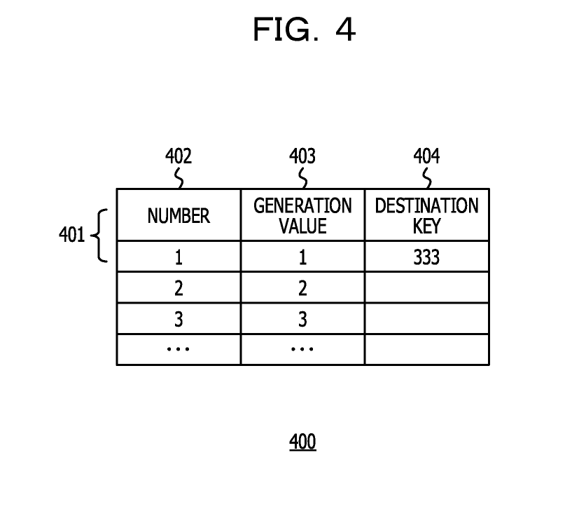

FIG. 4 is a diagram illustrating the destination management information 400 according to the first embodiment. The destination management information 400 includes destination information 401. The destination information 401 includes a number 402, a generation value 403 and a destination key 404, which are associated with each other in the destination information 401. The number 402 may be a serial number assigned to the destination information 401, for example. Note that, in another embodiment, the number 402 does not have to be included in the destination information 401. In the generation value 403, generations set in the device generation value 301 of the information processing device 1 may be registered sequentially from the initial value. In the destination key 404, the unique key 303 of the information processing device 1 is registered, the information processing device 1 being the destination to which the use right of a content is transferred in execution of the use right transfer processing according to the embodiment. In the use right transfer processing according to the first embodiment, for example, the control unit 200 in the information processing device 1 receives the unique key 303 of the information processing device 1 that is the destination to which the use right of the content is transferred. Then, the control unit 200 in the information processing device 1 stores the device generation value 301 stored in the storage unit 220 and the received unique key 303 of the destination information processing device 1 in the destination management information 400 while associating the device generation value 301 with the unique key 303. More specifically, in the destination management information 400, the unique key 303 of the destination information processing device 1 in the use right transfer processing previously executed by the information processing device 1, for example, is recorded together with the device generation value 301 of the information processing device 1 when the use right transfer processing is executed. In the example illustrated in FIG. 4, the information processing device 1 has executed the use right transfer processing once in the past, and thus the unique key 303: 333 of the destination information processing device 1 is recorded in association with the generation value 403: 1 of the information processing device 1 in the row of the number 402: 1 in the destination management information 400.

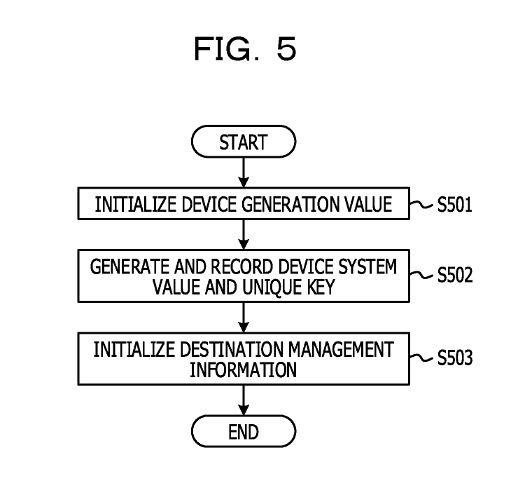

FIG. 5 is a flowchart illustrating setting processing of the information processing device 1 according to the first embodiment. The setting processing may be executed by the control unit 200 in the information processing device 1 before shipment from the manufacturing plant of the information processing device 1, or the like, for example. An operation flow of the setting processing is performed by the control unit 200 in the information processing device 1, for example, reading and executing the program 230 stored in the storage unit 220. In one embodiment, the operation flow illustrated in FIG. 5 is started when an instruction to execute the setting processing is inputted to the control unit 200 in the information processing device 1.

In Step 501 (hereinafter, Step is described as “S”, for example, described as S501), the control unit 200 in the information processing device 1 initializes the device generation value 301. Note that, in the first embodiment, the initial value of the device generation value 301 is “1” and the range of the device generation value 301 is “1 to 998”. The device generation value 301 is a value that is increased by 1 every time the use right transfer processing is executed. Therefore, in the first embodiment, the control unit 200 sets the device generation value 301 to 1 in S501. In S502, the control unit 200 generates the device system value 302 and the unique key 303, and stores the generated device system value 302 and unique key 303 in the storage unit 220. As the device system value 302, an arbitrary value may be set as long as the value to be set is a common value among devices within a group permitted to transfer the use right of a content, for example. Moreover, the control unit 200 may generate an encryption key unique to each of the information processing devices 1 by using a predetermined algorithm as the unique key 303, based on the unique information uniquely allocated to each of the information processing devices 1, and store the generated encryption key in the storage unit 220. In S503, the control unit 200 initializes the destination management information 400. For example, the control unit 200 empties the entire column of the destination key 404 in the destination information 401, thereby enabling the row of the number 402: 1. This operation flow is terminated after the initialization of the destination management information 400.

Note that, in the operation flow illustrated in FIG. 5 described above, the control unit 200 in the information processing device 1 functions as the setting unit 210, for example, during the processing from S501 to S503.

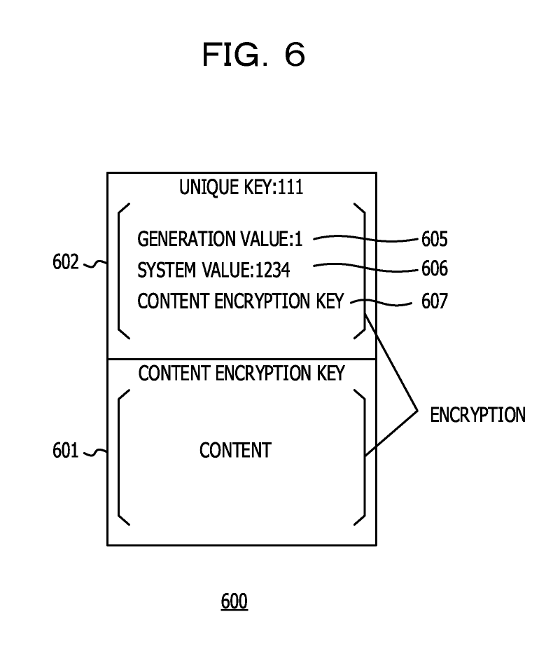

FIG. 6 is a diagram illustrating the content 600 according to the first embodiment. The content 600 includes an encrypted content 601 and use right information 602. The encrypted content 601 includes encryption data generated using a content encryption key 607 to encrypt content data such as music, a video, an image, an electronic book, a program or text data, for example. In the use right information 602, a generation value 605, a system value 606 and a content encryption key 607 of the content are included while being encrypted with the unique key of the information processing device 1. Note that, in the generation value 605 and the system value 606, the values set in the device generation value 301 and the device system value 302 of the information processing device 1, which executes recording during recording of the content 600, for example, are registered. Moreover, in the content encryption key 607, a random value generated by the information processing device 1 which executes the recording of the content 600, for example, may be registered.

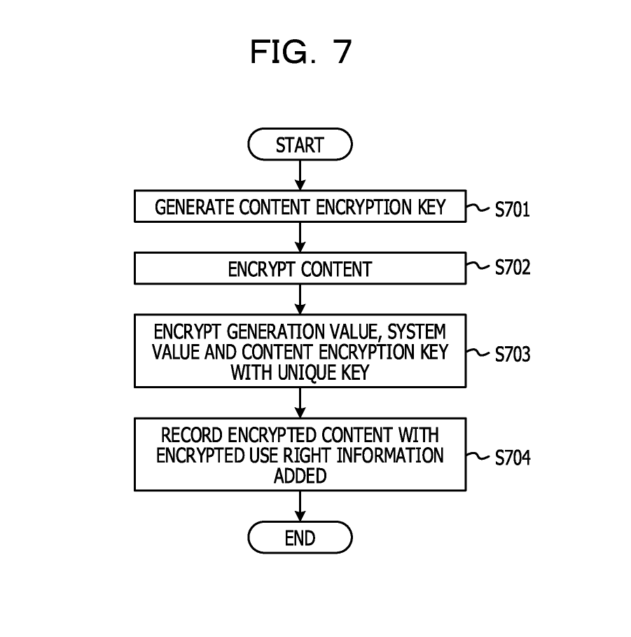

FIG. 7 is a flowchart illustrating processing of recording the content 600 according to the first embodiment. The processing of recording the content 600 is performed by the control unit 200 in the information processing device 1, for example, reading and executing the program 230 stored in the storage unit 220. In one embodiment, an operation flow illustrated in FIG. 7 is started when an instruction to receive content data from the distribution device 10 is inputted to the control unit 200.

In S701, the control unit 200 in the information processing device 1 generates a content encryption key to an encrypt content. The control unit 200 in the information processing device 1 may generate a random value, for example, and use the generated value as the content encryption key 607. The content encryption key 607 may be a title key, for example. In S702, the control unit 200 uses the generated content encryption key 607 to encrypt the content data received from the distribution device 10, for example, and thus generates the encrypted content 601. In S703, the control unit 200 reads the device generation value 301, the device system value 302 and the unique key 303 from the storage unit 220. Then, the control unit 200 registers the read device generation value 301 and device system value 302 as the generation value 605 and the system value 606 in the use right information 602 of the content, respectively. Moreover, the control unit 200 registers the content encryption key 607, which is used to encrypt the content data, in the use right information 602. Subsequently, the control unit 200 uses the unique key 303 read from the storage unit 220 to encrypt the use right information 602. In S704, the control unit 200 generates the content 600 by adding the encrypted use right information 602 to the generated encrypted content 601, and records the content 600 in the storage unit 220. The operation flow illustrated in FIG. 7 is terminated after the content 600 is recorded in the storage unit 220. Note that, when the device information 300 of the information processing device 1 is in the state of the example illustrated in FIG. 3, for example, the content 600 illustrated in FIG. 6 is recorded in the storage unit 220 by the operation flow illustrated in FIG. 7.

In the operation flow illustrated in FIG. 7 described above, the control unit 200 in the information processing device 1 functions as the saving unit 217, for example, during the processing from S701 to S704.

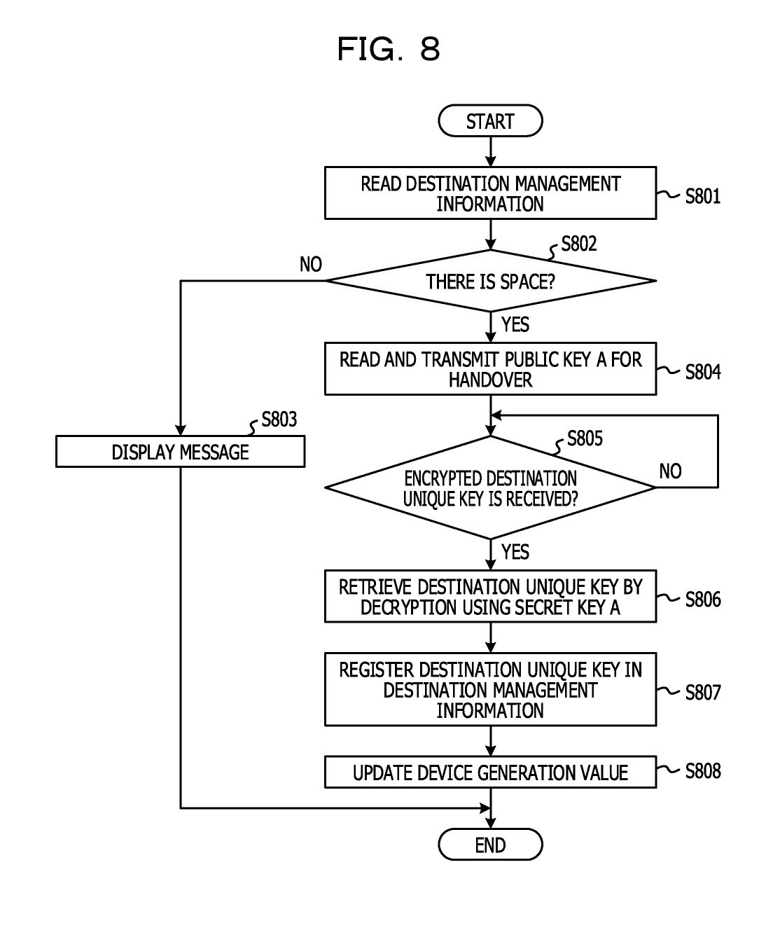

FIG. 8 is a flowchart illustrating use right transfer processing executed by the information processing device 1 that is a source from which the use right of a content is transferred according to the first embodiment. An operation flow illustrated in FIG. 8 is performed by the control unit 200 in the information processing device 1, for example, reading and executing the program 230 stored in the storage unit 220. In one embodiment, when an instruction to execute the use right transfer processing is inputted to the control unit 200 in the source information processing device 1, the information processing device 1 establishes connection with the information processing device 1 that is the transfer destination of the use right of the content. Then, when the connection is established, the source information processing device 1 may start the use right transfer processing in FIG. 8. Note that the connection between the source information processing device 1 and the destination information processing device 1 may be radio connection using an NFC communication device and an infrared communication device or wired connection using a cable or the like. NFC stands for Near Field Communication.

In S801, the control unit 200 in the information processing device 1 reads the destination management information 400. In S802, the control unit 200 determines whether or not there is a space in the read destination management information 400. When there is no space (No in S802), the flow advances to S803 where the control unit 200 displays a message indicating that the use right may not be transferred such as “transfer is impossible” on a display screen in the information processing device 1, for example. Then, this operation flow is terminated. On the other hand, when there is a space in the read destination management information 400 (Yes in S802), the flow advances to S804.

In S804, the control unit 200 reads a public key A for handing over the unique key 303 of the destination information processing device 1, and transmits the read public key A to the information processing device 1 that is the destination of the use right of the content. In S805, the control unit 200 determines whether or not the unique key 303 encrypted using the public key A is received from the destination information processing device 1. When the unique key 303 is not received from the destination information processing device 1 (No in S805), the flow repeats S805 until the unique key 303 of the destination information processing device 1 is received. On the other hand, when the unique key 303 of the destination information processing device 1 is received (Yes in S805), the flow advances to S806. In S806, the control unit 200 uses a secret key A to be paired up with the public key A for handover to decrypt the unique key 303 encrypted using the public key A, thereby retrieving the unique key 303 of the destination information processing device 1.

In S807, the control unit 200 reads the device generation value 301 from the storage unit 220, and registers the unique key 303 of the destination information processing device 1, which is decrypted in S806, in the destination key 404 in the destination information 401 having a value corresponding to the device generation value 301 as the generation value 403. In S808, the control unit 200 updates the device generation value 301 by increasing the device generation value 301 by 1 and storing the obtained value in the storage unit 220. Then, this operation flow is terminated.

Note that, in the operation flow illustrated in FIG. 8 described above, the control unit 200 in the information processing device 1 functions as the registration unit 214, for example, during the processing from S801 to S807. Moreover, the control unit 200 in the information processing device 1 functions as the update unit 213, for example, during the processing of S808.

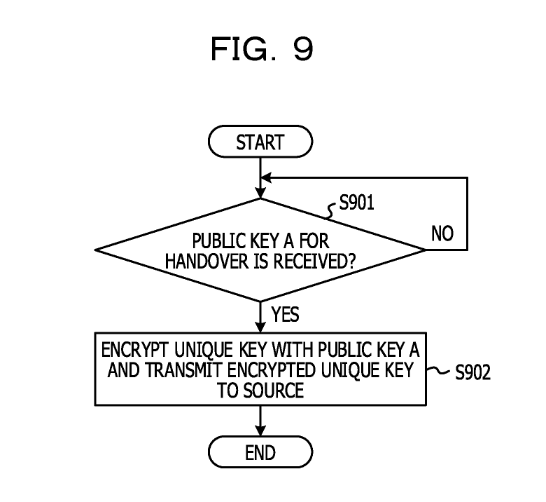

Subsequently, FIG. 9 is a flowchart illustrating use right transfer processing executed by the information processing device 1 that is the transfer destination of the use right of a content according to the first embodiment. An operation flow illustrated in FIG. 9 is performed by the control unit 200 in the information processing device 1, for example, reading and executing the program 230 stored in the storage unit 220. In one embodiment, when an instruction to execute the use right transfer processing is inputted to the control unit 200 in the source information processing device 1, the source information processing device 1 establishes connection with the information processing device 1 that is the transfer destination of the use right of the content. Then, when the connection is established, the destination information processing device 1 may start the use right transfer processing in FIG. 9. Note that the connection between the source information processing device 1 and the destination information processing device 1 may be radio communication using an NFC communication device and an infrared communication device or wired connection using a cable or the like.

In S901, the control unit 200 in the information processing device 1 that is the transfer destination of the use right of the content determines whether or not a public key A for handover is received from the source information processing device 1. When the public key A is not received (No in S901), the flow repeats S901 until the public key A is received. On the other hand, when the public key A is received from the source information processing device 1 (Yes in S901), the flow advances to S902. In S902, the control unit 200 in the destination information processing device 1 uses the received public key A to encrypt the unique key 303 in the storage unit 220, and transmits the encrypted unique key 303 to the source information processing device 1. Then, this operation flow is terminated.

Note that, in the operation flow illustrated in FIG. 9 described above, the control unit 200 in the information processing device 1 functions as the registration unit 214, for example, during the processing from S901 to S902.

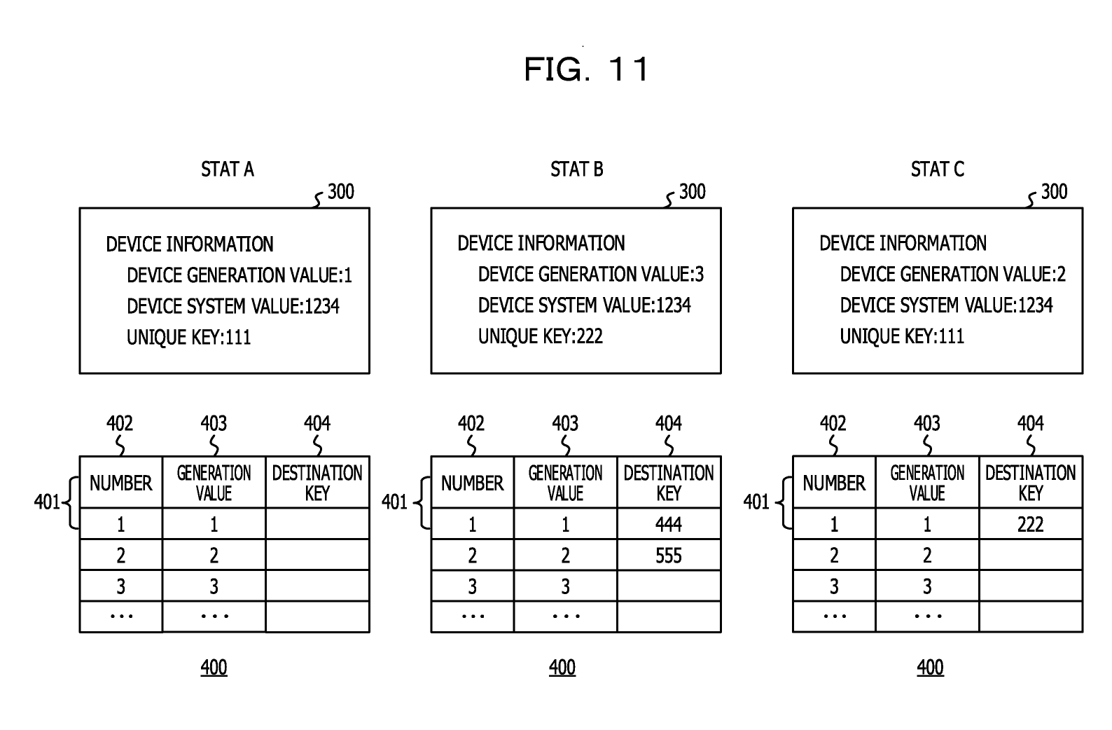

By the operation flows illustrated in FIGS. 8 and 9 described above, the unique key 303 of the destination information processing device 1 is registered in the destination management information 400 in the source information processing device 1. It is assumed, for example, that the device information 300 and the destination management information 400 of the source information processing device 1 are in a state A illustrated in FIG. 11. It is also assumed, for example, that the device information 300 and the destination management information 400 of the destination information processing device 1 are in a state B illustrated in FIG. 11. In this case, when the operation flows illustrated in FIGS. 8 and 9 are executed, the unique key 303: 222 of the destination information processing device 1 is transmitted to the source information processing device 1. Then, the unique key 303: 222 of the destination information processing device 1 is registered in the destination key 404 in the destination information 401 having the same value as the device generation value 301: 1 of the source information processing device 1 as the generation value 403. Moreover, the device generation value 301 in the device information 300 of the source information processing device 1 is increased by 1. As a result, the state of the device information 300 and the destination management information 400 of the source information processing device 1 is changed from the state A to a state C illustrated in FIG. 11.

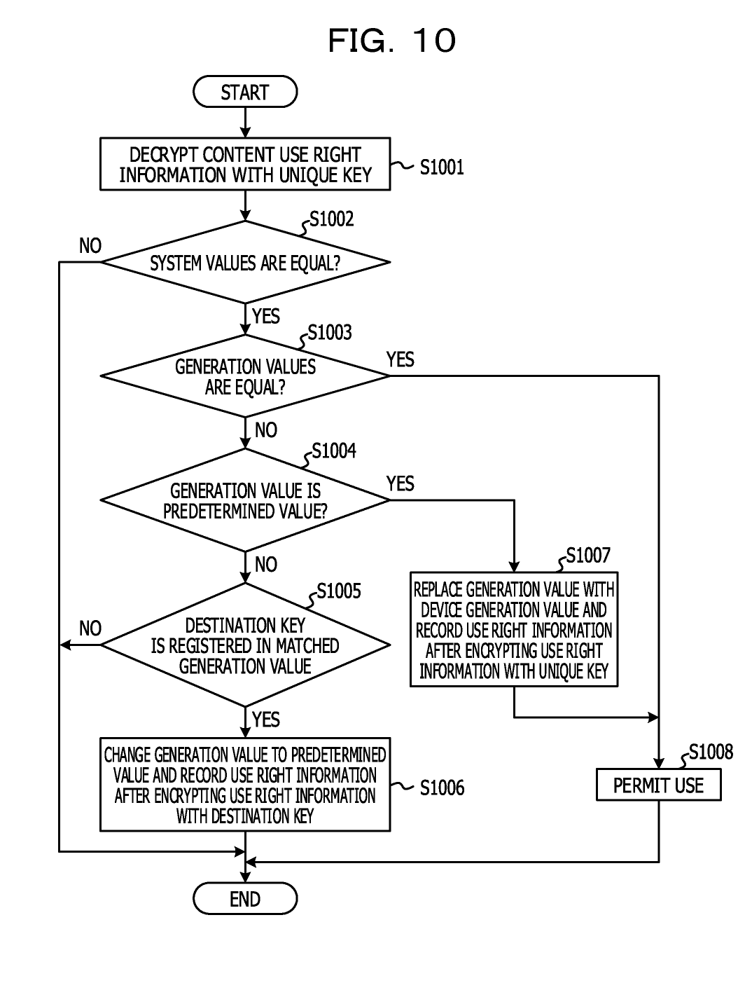

FIG. 10 is a flowchart illustrating content moving processing to the destination information processing device 1 according to the first embodiment. An operation flow of the content moving processing to the destination information processing device 1 illustrated in FIG. 10 is performed by the control unit 200 in the information processing device 1, for example, reading and executing the program 230 stored in the storage unit 220. In one embodiment, when a use instruction such as reproduction of the content is inputted to the control unit 200 in the information processing device 1, the content moving processing to the destination information processing device 1 illustrated in FIG. 10 may be started. In another embodiment, when an instruction to move the content is inputted to the control unit 200 in the information processing device 1, the content moving processing to the destination information processing device 1 illustrated in FIG. 10 may be started.

In S1001, the control unit 200 in the information processing device 1 uses the unique key 303 stored as the device information 300 in the storage unit 220 to decrypt the use right information 602 in the content 600. In S1002, the control unit 200 in the information processing device 1 determines whether or not the system value 606 decrypted from the use right information 602 is equal to the device system value 302 stored as the device information 300 in the storage unit 220.

When the system value 606 decrypted from the use right information 602 in the content 600 is different from the device system value 302 (No in S1002), this operation flow is terminated. On the other hand, when the system value 606 decrypted from the use right information 602 in the content 600 is equal to the device system value 302 (Yes in S1002), the flow advances to S1003.

Note that, in the determination in S1002, the control unit 200 in the information processing device 1 may determine, based on the system value, whether or not the use right information 602 is successfully decrypted, for example. For example, if the system value 606 decrypted from the use right information 602 in the content 600 is equal to the device system value 302, this means that the control unit 200 has succeeded in decrypting the use right information 602. Also, here, successful decryption means that encrypted information may be correctly decrypted to the original information before execution of encryption. Meanwhile, if the system value 606 decrypted from the use right information 602 in the content 600 is different from the device system value 302, this means that an encryption key used to encrypt the use right information 602, for example, is different from an encryption key used for decryption. In this case, the use right information 602 in the content 600, for example, is encrypted using a unique key 303 of another information processing device 1. Therefore, the content 600 is bound to the another information processing device 1, and thus may not be used.

Alternatively, in the determination in S1002, the control unit 200 in the information processing device 1 may determine, based on the system value, whether or not the content may be used, for example. More specifically, if the system value 606 decrypted from the use right information 602 in the content 600 is equal to the device system value 302, for example, this may mean that the control unit 200 may use the content. On the other hand, if the system value 606 decrypted from the use right information 602 in the content 600 is different from the device system value 302, for example, this may mean that the content 600 has a system value 606 of another group that is not permitted to transfer the use right. In other words, if the system value 606 decrypted from the use right information 602 in the content 600 is different from the device system value 302, for example, this may mean that the content is not data generated by the information processing device 1 having the same system value 606, and thus may not be used.

In S1003, the control unit 200 in the information processing device 1 determines whether or not the generation value 605 in the use right information 602 is equal to the device generation value 301 registered as the device information 300 in the information processing device 1. When the generation value 605 in the use right information 602 is equal to the device generation value 301 registered as the device information 300 in the information processing device 1 (Yes in S1003), the flow advances to S1008. In S1008, the control unit 200 in the information processing device 1 permits the use of the content 600. For example, the control unit 200 may permit reproduction of the content by decrypting the encrypted content 601 in the content 600 with the content encryption key 607 decrypted from the use right information 602 in S1001. Therefore, in this case, the control unit 200 in the information processing device 1 reproduces the content 600, for example, and the user may watch or listen to the content. Note that the use of the content 600 is not limited to reproduction but may be display of images, programs and text data, execution of programs, and execution of backup of the content and the like.

On the other hand, when the generation value 605 in the use right information 602 is different from the device generation value 301 registered as the device information 300 in the information processing device 1 (No in S1003), the flow advances to S1004. In S1004, the control unit 200 in the information processing device 1 determines whether or not the generation value 605 decrypted from the use right information 602 is a predetermined value. Note that the predetermined value is a value set to indicate that the use right of the content 600 is transferred by the use right transfer processing, and may be stored in the storage unit 220, for example. Note that, in the first embodiment and the second embodiment to be described later, description is given, as an example, of the case where “999” is used as the predetermined value. However, the predetermined value is not limited thereto, but an arbitrary value may be set as long as the value to be set is not within the range of the value set as the device generation value 301, for example. In other words, in the first embodiment, for example, the predetermined value may be set to an arbitrary value outside the range: 1 to 998 of the value set as the device generation value 301.

When the generation value 605 decrypted from the use right information 602 is the predetermined value: 999 (Yes in S1004), the flow advances to S1007. In S1007, the control unit 200 in the information processing device 1 replaces the generation value 605 set to the predetermined value: 999 in the use right information 602 of the content with the value set as the device generation value 301 of the information processing device 1, thereby updating the generation value 605 in the use right information 602. Thereafter, the updated use right information 602 is encrypted using the unique key 303 registered as the device information 300 in the information processing device 1, and then the flow advances to S1008. After the control unit 200 permits the use of the content 600 in S1008, this operation flow is terminated.

On the other hand, when the generation value 605 decrypted from the use right information 602 is not the predetermined value: 999 in S1004 (No in S1004), the flow advances to S1005. In S1005, the control unit 200 in the information processing device 1 determines whether or not the destination key 404 is registered in the destination information 401 having the generation value 403 equal to the generation value 605 decrypted from the use right information 602. When the destination key 404 is not registered in the destination information 401 having the generation value 403 equal to the generation value 605 decrypted from the use right information 602 (No in S1005), this operation flow is terminated.

On the other hand, when the destination key 404 is registered in the destination information 401 having the generation value 403 equal to the generation value 605 decrypted from the use right information 602 (Yes in S1005), the flow advances to S1006. In S1006, the control unit 200 in the information processing device 1 reads the destination key 404 in the destination information 401 having the generation value 403 equal to the generation value 605 decrypted from the use right information 602. Then, the control unit 200 in the information processing device 1 changes the generation value 605 in the use right information 602 to the predetermined value: 999, generates a content 600 by encrypting the use right information 602 with the read destination key 404, and records the generated content 600 in the storage unit 220. After the content 600 is recorded in the storage unit 220, this operation flow is terminated.

Note that, in the operation flow illustrated in FIG. 10 described above, the control unit 200 in the information processing device 1 functions as the determination unit 211, for example, during the processing from S1001 to S1002. Also, the control unit 200 in the information processing device 1 functions as the permission unit 212, for example, during the processing of S1003 and S1008. Moreover, the control unit 200 in the information processing device 1 functions as the first transfer unit 215, for example, during the processing from S1004 to S1007.

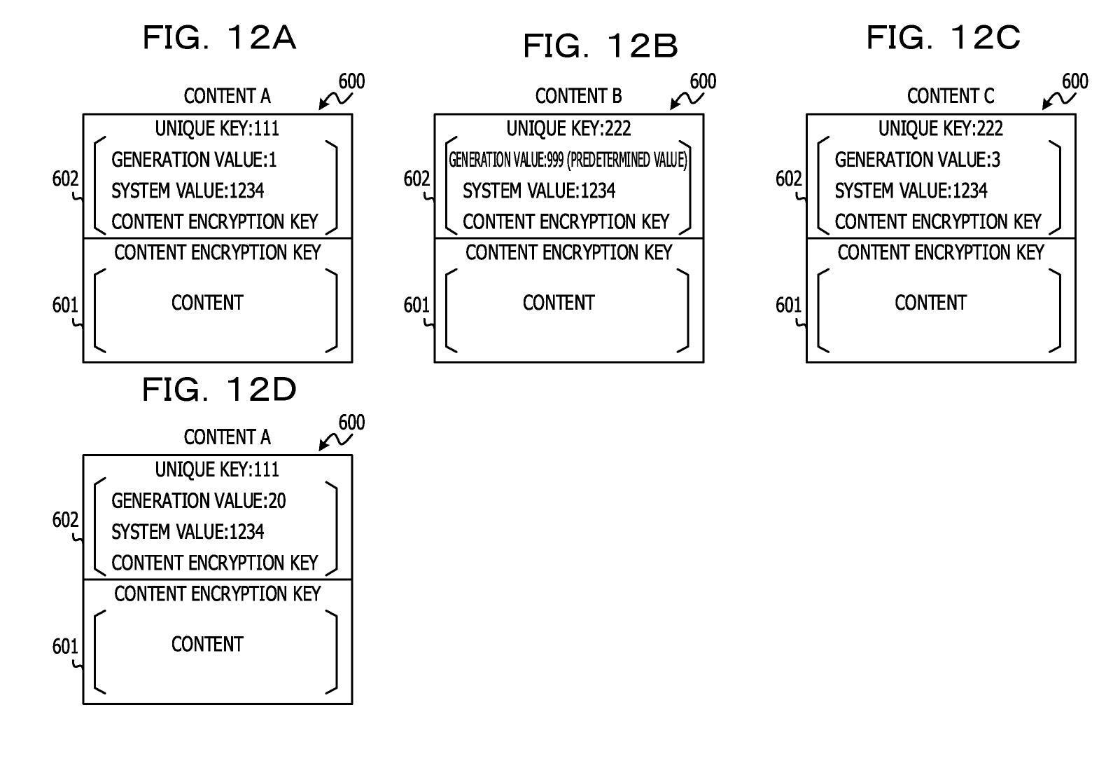

Next, description is given of permission to use the content and transfer of the use right of the content by the operation flow illustrated in FIG. 10 by giving some examples of the information processing device 1 and the content 600. FIG. 11 is a diagram illustrating some states of the information processing device 1 according to the first embodiment. FIGS. 12A, 12B, 12C, and 12D are diagrams illustrating some contents 600 according to the embodiment.

<Case 1>

Description is given of a case where the device information 300 and the destination management information 400 of the information processing device 1 are in the state A illustrated in FIG. 11 and the operation flow illustrated in FIG. 10 is executed for a content A illustrated in FIG. 12A. Note that the state A of the information processing device 1 illustrated in FIG. 11 is a state where the setting is performed by the setting processing illustrated in FIG. 5 described above, for example. Also, the content A illustrated in FIG. 12A is the content 600 generated when the content recording processing illustrated in FIG. 7 is executed by the information processing device 1 in the state A, for example.

In this case, in S1001 of FIG. 10, the use right information 602 of the content A is encrypted using a unique key 303: 111. Thus, the control unit 200 in the information processing device 1 performs decryption using the unique key 303: 111 in the storage unit 220 in S1001, and successfully decrypts the use right information 602. A system value 606: 1234 and a generation value 605: 1, which are decrypted from the use right information 602, are equal to a device system value 302: 1234 and a device generation value 301: 1 of the information processing device 1. Thus, the results of the determinations in S1002 and S1003 are Yes, and the control unit 200 in the information processing device 1 permits the use of the content A in S1008. Therefore, the control unit 200 in the information processing device 1 having the content A recorded therein, for example, may reproduce the content A by decrypting the encrypted content 601 with the content encryption key 607 decrypted from the use right information 602. As a result, the user may watch the content A.

<Case 2>

Description is given of a case where the device information 300 and the destination management information 400 of the information processing device 1 are in the state B illustrated in FIG. 11 and the operation flow illustrated in FIG. 10 is executed for the content A illustrated in FIG. 12A.

In this case, a unique key 303: 222 of the information processing device 1 is different from the unique key 303: 111 used to encrypt the use right information 602 of the content A. Thus, in S1001, the control unit 200 fails to decrypt the use right information 602 encrypted using the unique key 303: 111 of the content A. Then, in S1002, the device system value 302 becomes a value different from the system value 606 in the use right information 602 of the content. In this case, the result of the determination in S1002 is No, and the information processing device 1 terminates the processing without giving permission to use the content A. In other words, the content A recorded by the content recording processing illustrated in FIG. 7 in the information processing device 1 in the state A, for example, may not be used by another information processing device 1 since the unique key 303 of the another information processing device 1 is different from that of the information processing device 1 in the state A.

<Case 3>

Description is given of a case where the device information 300 and the destination management information 400 of the information processing device 1 are in the state C illustrated in FIG. 11 and the operation flow illustrated in FIG. 10 is executed for the content A illustrated in FIG. 12A.

When the transfer processing according to the first embodiment illustrated in FIGS. 8 and 9 is executed after the content A is recorded in the storage unit 220 in the information processing device 1 in the state A illustrated in FIG. 11, for example, the device information 300 and the destination management information 400 of the information processing device 1 are updated to the state C. When the operation flow illustrated in FIG. 10 is executed for the content A by the information processing device 1 in the state C, the control unit 200 succeeds in decrypting the use right information 602 encrypted using the unique key 303: 111, in S1001, since the unique key 303 of the information processing device 1 is “111”. Also, the device system value 302 is equal to the system value in S1002, and the result of the determination in S1002 is Yes. On the other hand, the device generation value 301: 2 of the information processing device 1 is different from the generation value 605: 1 of the use right information 602 of the content A, and is not the predetermined value. Thus, the results of the determinations by the control unit 200 in S1003 and S1004 are both No. In S1005, the destination key: 222 is registered in the destination information 401 in the destination management information 400 in the state C having a value equal to the generation value 605: 1 of the content A illustrated in FIG. 11. Thus, the result of the determination in S1005 is Yes, and the control unit 200 rewrites the generation value 605 in the use right information 602 with the predetermined value: 999 and stores the content re-encrypted using the destination key: 222 in the storage unit 220. Note that the content stored here is the content B illustrated in FIG. 12B, for example.

As described above, even the information processing device 1 having the content A recorded therein may not reproduce the content A, when the transfer processing illustrated in FIGS. 8 and 9 is executed after the recording, since the device generation value 301 is updated. Moreover, in this case, the use right information 602 of the content A is rewritten into the content B to be used by the destination information processing device 1 according to the information registered in the destination information 401. Therefore, it is assumed, for example, that a backup of the content A is made in some way by the information processing device 1 and the content A is restored from the backup after execution of the transfer processing according to the first embodiment. In this case, again, the restored content A may not be reproduced by the information processing device 1 in the state C. Also, the content A is rewritten into the content B according to the information registered in the destination information 401. More specifically, even when the content may be restored by backup, restoring or the like, the number of devices having access to the content is not increased.

<Case 4>

Description is given of a case where the device information 300 and the destination management information 400 of the information processing device 1 are in the state B illustrated in FIG. 11 and the operation flow illustrated in FIG. 10 is executed for the content B illustrated in FIG. 12B. Note that it is assumed, for example, that the source information processing device 1 in the state A executes the transfer processing of the use right to the destination information processing device in the state B according to the operation flow illustrated in FIGS. 8 and 9. When the source information processing device 1 thus changed to the state C executes the operation flow illustrated in FIG. 10, the content B is generated.

Since the information processing device 1 in the state B has the unique key 303: 222, the control unit 200 in the information processing device 1 succeeds in decrypting the use right information 602 encrypted using the unique key 303: 222 of the content B in S1001. The device system value 302 is equal to the system value in S1002, and the result of the determination in S1002 is Yes. Moreover, since the generation value of the content B is set to the predetermined value: 999, the result of the determination by the control unit 200 in the information processing device 1 is No in S1003 and Yes in S1004. Then, in S1007, the control unit 200 in the information processing device 1 replaces the predetermined value in the use right information 602 with the device generation value 301: 3 to re-encrypt the use right information 602 with the unique key 303: 222, thereby generating the content C (FIG. 12C). Subsequently, in S1008, the control unit 200 in the information processing device 1 permits the use of the content C.

When the information processing device 1 in the state B executes the operation flow illustrated in FIG. 10 again for the content C thus generated, the operation flow illustrated in FIG. 10 proceeds in the same manner as Case 1 described above, and the use of the content C is permitted in S1008. Meanwhile, even if the information processing device 1 in the state C, that is the transfer source of the use right of the content, executes the operation flow illustrated in FIG. 10 for the content C, the use right information may not be decrypted with the unique key 303: 111. Thus, the operation flow illustrated in FIG. 10 proceeds in the same manner as Case 2 described above, and the content may not be used.

Note that the description is given of the example where the generation value 605 is changed to the predetermined value in S1006 in the content moving processing described with reference to FIG. 10, for example. Here, the changing of the generation value 605 to the predetermined value has the following advantage, for example. Specifically, even when the device generation value 301 is updated in the destination information processing device 1 before the use of the content 600 is started at the destination after the execution of the moving of the content 600 at the source, for example, the destination information processing device 1 is allowed to use the content 600. However, the embodiment is not limited thereto. For example, in another embodiment, during the handover of the unique key 303 of the destination information processing device 1 in S805 and S902 described above, the device generation value 301 of the destination information processing device 1 may also be handed over and registered in the source management information 1300. In this case, in S1006, the control unit 200 may set the device generation value 301 of the destination information processing device 1, which is registered in the source management information 1300, instead of setting the predetermined value as the generation value 605.

<Case 5>

As a further example, description is given of a case where the device information 300 and the destination management information 400 of the information processing device 1 are in the state A illustrated in FIG. 11 and the operation flow illustrated in FIG. 10 is executed for the content D illustrated in FIG. 12D. Note that the generation value: 20 of the content D does not match the device generation value 301: 1 of the information processing device 1 in the state A, for example, and the destination key 404 corresponding to the generation value: 20 is not registered in the destination management information 400. Thus, the content D may be a content generated in an unauthorized manner.

In this case, since the unique key 303 of the information processing device 1 in the state A is “111”, the control unit 200 in the information processing device 1 succeeds in decrypting the use right information 602 in S1001, the use right information 602 being encrypted using the unique key 303: 111 of the content D. Also, since the device system value 302 is equal to the system value 606 of the content D in S1002, the result of the determination in S1002 is Yes. Subsequently, the device generation value 301 of the information processing device 1 is “1”, while the generation value of the content D is set to “20”. Thus, the results of the determinations by the control unit 200 in S1003 and S1004 are both No. Moreover, since the generation value “20” of the content D is not registered in the destination management information 400 of the information processing device 1, the result of the determination in S1005 is No, and this operation flow is terminated. Therefore, as to a content that may be generated in an unauthorized manner, the content having a generation value 605 that is supposed to be non-existent, such as the content D, the use thereof is not permitted.

As described above, according to the first embodiment, the use right of the content may be transferred to another device while limiting the device having the use right of the content to one device. Furthermore, as described in Case 3, for example, it is assumed that a backup of the content 600 is made in some way and the content 600 is restored from the backup after execution of the transfer processing according to the first embodiment. In such a case, again, the right to use the restored content 600 is transferred based on the device generation value 301 updated by the transfer processing and the destination management information 400. Thus, the device having the use right may be limited to one device.

Thus, a company holding the copyright of the content, for example, may feel safe to provide the content to the information processing device 1. Moreover, the user does not have to give up using the content recorded in the information processing device 1 in changing the model of the information processing device 1 or the like, for example, and may use the content by transferring the use right to a new information processing device 1. Furthermore, according to the first embodiment, the user does not have to bring the information processing device 1 to a place that may be trusted by a manufacturer, such as a factory, in order to transfer the use right of the content to another information processing device 1, for example. This enables reduction in time for which the user has no access to the content in moving the use right of the content.

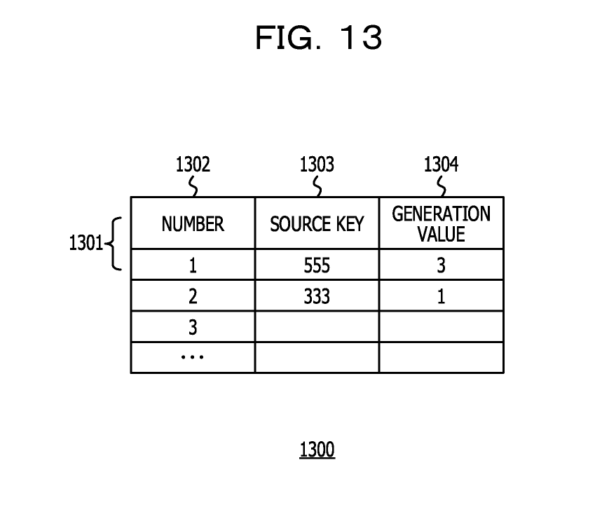

FIGS. 13 to 20 described below are diagrams illustrating the second embodiment. In the first embodiment, the description is given of the example where the source information processing device 1 executes the content moving processing the content to the destination information processing device 1. In the second embodiment, description is given of an example where both of the source information processing device 1 and the destination information processing device 1 may execute the content moving processing the content to the destination information processing device 1.

In the second embodiment, the information processing device 1 includes source management information 1300 in addition to the destination management information 400. The source management information 1300 may be stored in the storage unit 220, for example. FIG. 13 is a diagram illustrating the source management information 1300 according to the second embodiment. In the source management information 1300, source information 1301 is registered. The source information 1301 includes a number 1302, a source key 1303 and a generation value 1304, which are associated with each other in the source information 1301. The number 1302 may be a serial number assigned to the source information 1301, for example. Note that, in another embodiment, the number 1302 does not have to be included in the source information 1301. In the source key 1303, the unique key 303 of the information processing device 1 is registered, the information processing device 1 being the transfer source of the use right of the content 600 when executing the use right transfer processing according to the second embodiment. In the generation value 1304, the device generation value 301 of the information processing device 1 is registered, the information processing device 1 being the transfer source of the use right of the content 600 when executing the use right transfer processing according to the second embodiment. In the use right transfer processing according to the second embodiment, for example, the control unit 200 in the information processing device 1 receives the unique key 303 and the device generation value 301 of the source information processing device 1. Then, the control unit 200 in the destination information processing device 1 registers the received unique key 303 and device generation value 301 in the source management information 1300 while associating the unique key 303 with the device generation value 301.

Therefore, in the source management information 1300, the unique key 303 of the source information processing device 1 in the use right transfer processing previously executed by the information processing device 1, for example, is registered together with the device generation value 301 of the information processing device 1 when the transfer processing is executed. In the example of the source management information 1300 illustrated in FIG. 13, the transfer processing of the use right of the content 600 has been executed twice in the past. Thus, in the row of the number 1302: 1 in the source management information 1300, the unique key 303: 555 of the source information processing device 1 is registered together with the generation value: 3. Also, in the row of the number 1302: 2 in the source management information 1300, the unique key 303: 333 of the source information processing device 1 is registered together with the generation value: 1.

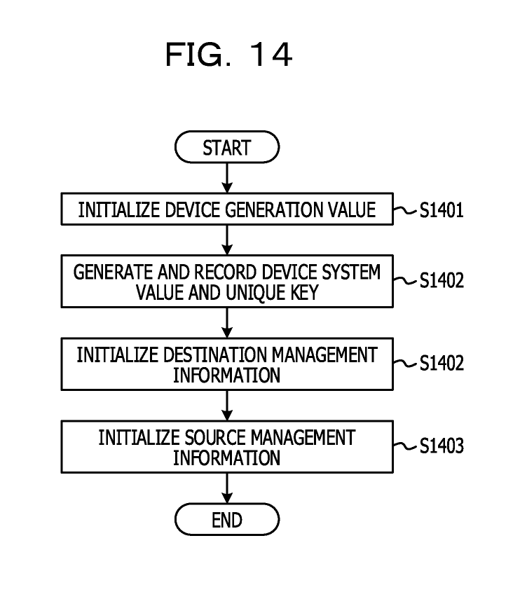

FIG. 14 is a flowchart illustrating setting processing of the information processing device 1 according to the second embodiment. The setting processing may be executed by the control unit 200 in the information processing device 1 before shipment from the manufacturing plant of the information processing device 1, or the like, for example. An operation flow of the setting processing is performed by the control unit 200 in the information processing device 1, for example, reading and executing the program 230 stored in the storage unit 220. In one embodiment, the operation flow illustrated in FIG. 14 is started when an instruction to execute the setting processing is inputted to the control unit 200 in the information processing device 1.

In Step 1401, the control unit 200 in the information processing device 1 initializes the device generation value 301. Note that, in the second embodiment, the initial value of the device generation value 301 is “1” and the range of the device generation value 301 is “1 to 998”. The device generation value 301 is a value that is increased by 1 every time the use right transfer processing is executed. Therefore, in the second embodiment, the control unit 200 sets the device generation value 301 to 1 in S1401. In S1402, the control unit 200 generates the device system value 302 and the unique key 303, and stores the generated device system value 302 and unique key 303 in the storage unit 220. As the device system value 302, an arbitrary value may be set as long as the value to be set is a common value among devices within a group permitted to transfer the use right of a content, for example. Moreover, the control unit 200 may generate a unique key 303 by using a predetermined algorithm, based on the unique information uniquely allocated to each of the information processing devices 1, and store the generated unique key in the storage unit 220. In S1403, the control unit 200 initializes the destination management information 400. For example, the control unit 200 empties the entire column of the destination key 404 in the destination information 401, thereby enabling the row of the number 402: 1. In S1404, the control unit 200 initializes the source management information 1300. For example, the control unit 200 empties the entire columns of the source key 1303 and the generation value 1304 in the source information 1301, thereby enabling the row of the number 1302: 1. This operation flow is terminated after the initialization of the source management information 1300.

Note that, in the operation flow illustrated in FIG. 14 described above, the control unit 200 in the information processing device 1 functions as the setting unit 210, for example, during the processing from S1401 to S1404.

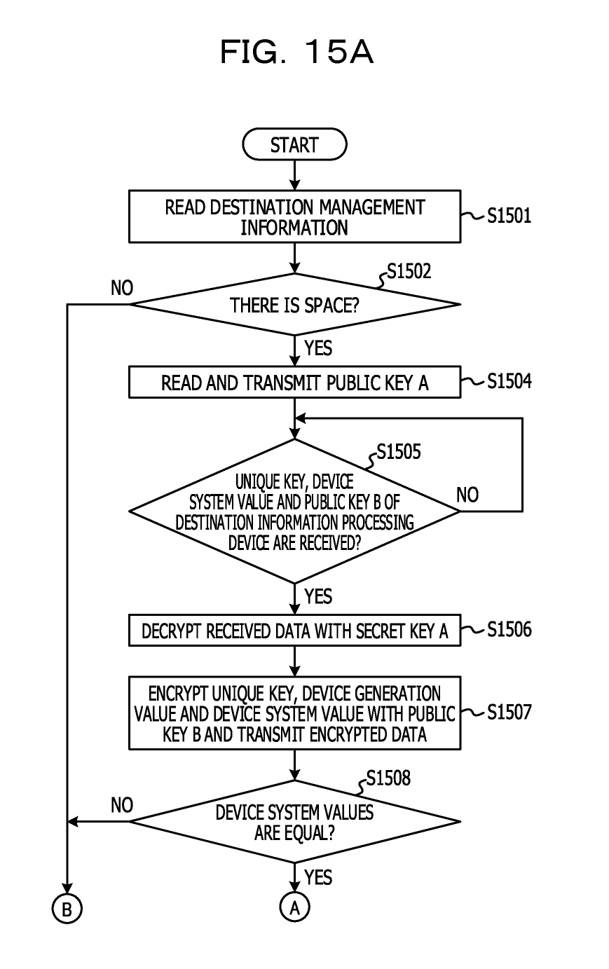

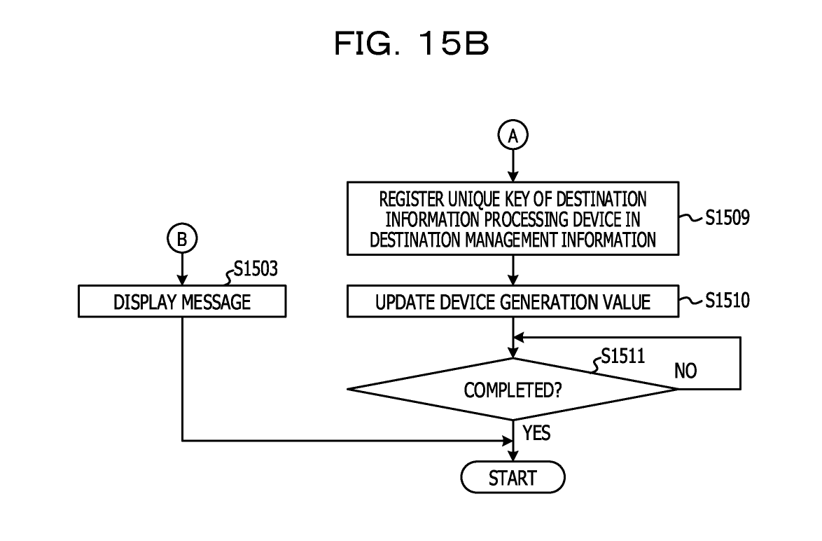

FIGS. 15A and 15B are flowcharts illustrating use right transfer processing executed by the information processing device 1 that is the transfer source of the use right of a content according to the second embodiment. An operation flows illustrated in FIGS. 15A and 15B are performed by the control unit 200 in the information processing device 1, for example, reading and executing the program 230 stored in the storage unit 220. In one embodiment, when an instruction to execute the use right transfer processing is inputted to the control unit 200 in the source information processing device 1, the source information processing device 1 establishes connection with the information processing device 1 that is the transfer destination of the use right of a content. Then, when the connection is established, the source information processing device 1 may start the use right transfer processing in FIGS. 15A and 15B.

In S1501, the control unit 200 in the information processing device 1 reads the destination management information 400. In S1502, the control unit 200 determines whether or not there is a space in the read destination management information 400. When there is no space (No in S1502), the flow advances to S1503 where the control unit 200 in the source information processing device 1 displays a message indicating that the use right may not be transferred such as “transfer is impossible” on a display screen in the information processing device 1, for example. Then, this operation flow is terminated. On the other hand, when there is a space in the read destination management information 400 (Yes in S1502), the flow advances to S1504.

In S1504, the control unit 200 in the source information processing device 1 reads a public key A for handing over the unique key 303, and transmits the read public key A to the information processing device 1 that is the transfer destination of the use right of the content. In S1505, the control unit 200 in the source information processing device 1 determines whether or not the unique key 303 and the device system value 302, which are encrypted using the transmitted public key A, and a public key B are received from the destination information processing device 1. When the unique key 303, the device system value 302 and the public key B are not received (No in S1505), the flow repeats S1505 until the unique key 303 and device system value 302 of the destination information processing device 1 and the public key B are received. On the other hand, when the unique key 303 and the device system value 302 of the destination information processing device 1, which are encrypted using the transmitted public key A, and the public key B are received (Yes in S1505), the flow advances to S1506. In S1506, the control unit 200 in the source information processing device 1 uses a secret key A to be paired up with the public key A to decrypt the unique key 303 and device system value 302 encrypted using the public key A, thereby retrieving the unique key 303 and device system value 302 of the destination information processing device 1.

In S1507, the control unit 200 in the source information processing device 1 uses the received public key B to encrypt the unique key 303, the device generation value 301 and the device system value 302 in the storage unit 220, and the encrypted unique key 303, device generation value 301 and device system value 302 to the destination information processing device 1. In S1508, the control unit 200 determines whether or not the device system value 302 of the destination information processing device 1 retrieved using the secret key A is equal to the device system value 302 set in the storage unit 220. When the device system value 302 of the destination information processing device 1 is different from the device system value 302 in the storage unit 220 (No in S1508), the flow advances to S1503 to display a message indicating that the use right may not be transferred. Then, this operation flow is terminated. On the other hand, when the device system value 302 of the destination information processing device 1 is equal to the device system value 302 set in the storage unit 220 (Yes in S1508), the flow advances to S1509.

In S1509, the control unit 200 registers the unique key 303 of the destination information processing device 1, which is decrypted in S1506, in the destination key 404 in the destination information 401 having a value equal to the device generation value 301 of the destination information processing device 1 retrieved using the secret key A, as the generation value 403. In S1510, the control unit 200 updates the device generation value 301 by changing the device generation value 301 to another value. For example, the control unit 200 in the source information processing device 1 may update the device generation value 301 by increasing the device generation value 301 by 1. In S1511, the control unit 200 waits to receive notification of processing completion from the information processing device 1 that is the transfer destination of the use right of the content. When no completion notification is received in S1511 (No in S1511), the control unit 200 repeats the processing of S1511. On the other hand, when the completion notification is received in S1511 (Yes in S1511), this operation flow is terminated.

Note that, in the operation flow illustrated in FIGS. 15A and 15B described above, the control unit 200 in the information processing device 1 functions as the registration unit 214, for example, during the processing from S1501 to S1509 and S1511. Moreover, the control unit 200 in the information processing device 1 functions as the update unit 213, for example, during the processing of S1510.

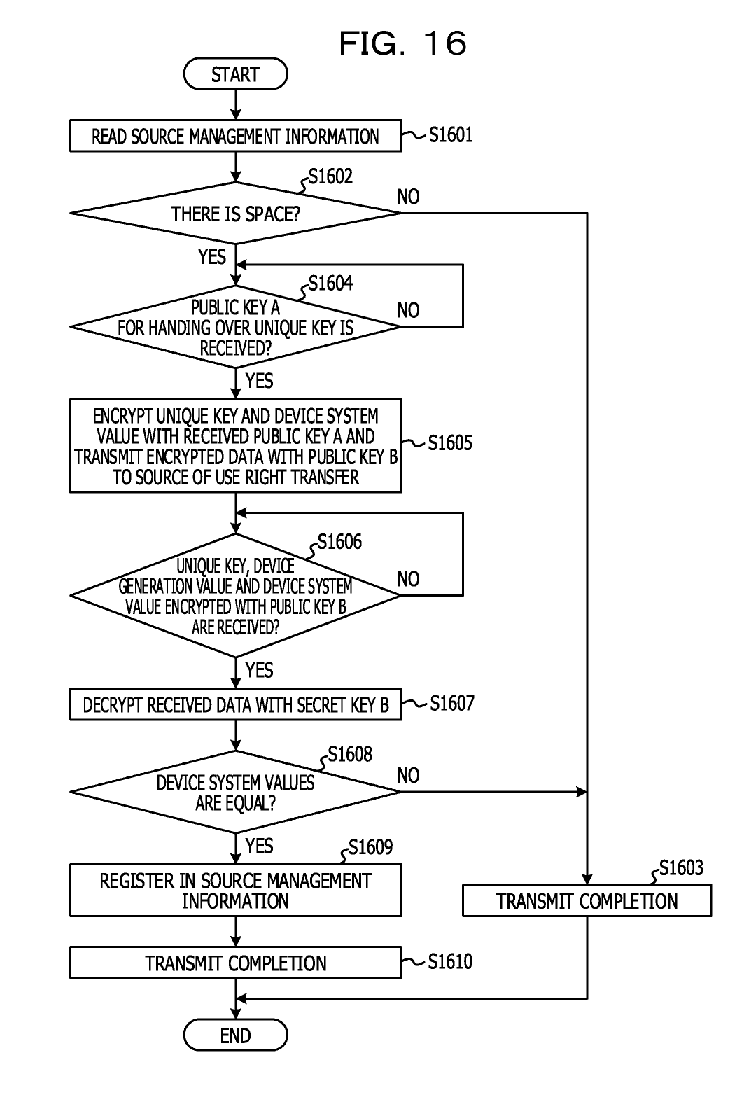

Subsequently, FIG. 16 is a flowchart illustrating use right transfer processing executed by the information processing device 1 that is the transfer destination of the use right of a content according to the second embodiment. An operation flow illustrated in FIG. 16 is performed by the control unit 200 in the information processing device 1, for example, reading and executing the program 230 stored in the storage unit 220. In one embodiment, when an instruction to execute the use right transfer processing is inputted to the control unit 200 in the source information processing device 1, the source information processing device 1 establishes connection with the information processing device 1 that is the transfer destination of the use right of the content. Then, when the connection is established, the destination information processing device 1 may start the use right transfer processing in FIG. 16.

In S1601, the control unit 200 in the information processing device 1 that is the transfer destination of the use right of the content reads the source management information 1300. In S1602, the control unit 200 in the destination information processing device 1 determines whether or not there is a space in the read source management information 1300. When there is no space (No in S1602), the flow advances to S1603 where the control unit 200 in the destination information processing device 1 displays a message indicating that the use right may not be transferred such as “transfer is impossible” on a display screen in the information processing device 1, for example. Then, this operation flow is terminated. On the other hand, when there is a space in the read source management information 1300 (Yes in S1602), the flow advances to S1604.

In S1604, the control unit 200 in the destination information processing device 1 determines whether or not a public key A for handing over the unique key 303 is received from the information processing device 1 that is the transfer source of the use right of the content. When the public key A is not received (No in S1604), the flow repeats S1604 until the public key A is received. On the other hand, when the public key A is received from the source information processing device 1 (Yes in S1604), the flow advances to S1605. In S1605, the control unit 200 in the destination information processing device 1 uses the received public key A to encrypt the unique key 303 and the device system value 302 in the storage unit 220, and transmits the encrypted unique key 303 and device system value 302 to the source information processing device 1 together with the public key B for handing over the unique key 303. Then, in S1606, the control unit 200 in the destination information processing device 1 determines whether or not the unique key 303, the device generation value and the device system value 302, which are encrypted using the public key B, are received from the source information processing device 1. When the unique key 303, the device generation value and the device system value 302 of the source information processing device 1, which are encrypted using the public key B, are not received (No in S1606), the flow repeats S1606. On the other hand, when the unique key 303, the device generation value and the device system value 302 of the source information processing device 1, which are encrypted using the public key B, are received (Yes in S1606), the flow advances to S1607.

In S1607, the control unit 200 in the destination information processing device 1 performs decryption using a secret key B to be paired up with the public key B to retrieve the unique key 303, the device generation value 301 and the device system value 302 of the source information processing device 1. In S1608, the control unit 200 determines whether or not the device system value 302 of the source information processing device 1 retrieved using the secret key B is equal to the device system value 302 stored in the storage unit 220. When the device system value 302 of the source information processing device 1 is different from the device system value 302 stored in the storage unit 220 (No in S1608), the flow advances to S1603 to display a message indicating that the use right may not be transferred. Then, this operation flow is terminated. On the other hand, when the device system value 302 of the source information processing device 1 is equal to the device system value 302 stored in the storage unit 220 (Yes in S1608), the flow advances to S1609.

In S1609, the control unit 200 in the destination information processing device 1 registers the received unique key 303 and device generation value 301 of the source information processing device 1 in the source management information 1300 while associating he unique key 303 with the device generation value 301. In S1610, the control unit 200 in the destination information processing device 1 transmits notification indicating completion of the processing to the source information processing device 1. Then, this operation flow is terminated.

Note that, in the operation flow illustrated in FIG. 16 described above, the control unit 200 in the information processing device 1 functions as the registration unit 214, for example, during the processing from S1601 to S1610.

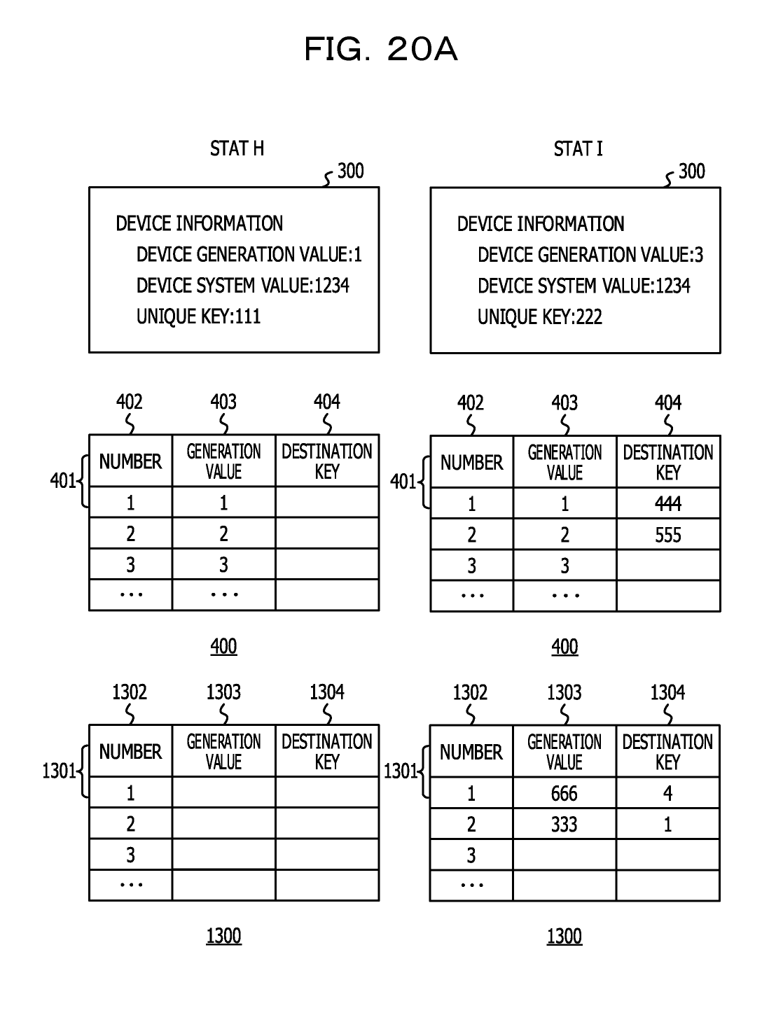

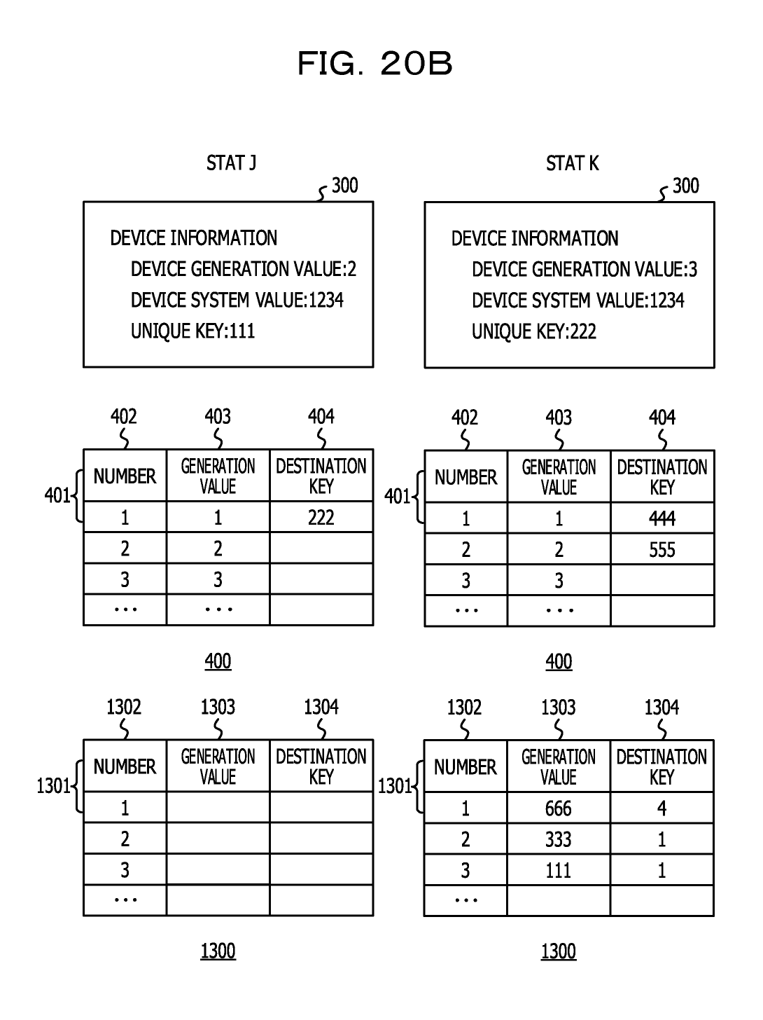

When the transfer processing is completed by the operation flows illustrated in FIGS. 15A, 15B and 16 described above, the unique key 303 of the destination information processing device 1 is registered in the destination management information 400 in the source information processing device 1. It is assumed, for example, that the device information 300, the destination management information 400 and the source management information 1300 of the source information processing device 1 are in a state H illustrated in FIG. 20A. It is also assumed, for example, that the device information 300, the destination management information 400 and the source management information 1300 of the destination information processing device 1 are in a state I illustrated in FIG. 20A.

In this case, when the operation flows illustrated in FIGS. 15A, 15B and 16 are executed, the unique key 303: 222 of the destination information processing device 1 is transmitted to the source information processing device 1. Then, the unique key 303: 222 of the destination information processing device 1 is registered in the destination key 404 in the destination information 401 having the same value as the device generation value 301: 1 of the source information processing device 1 as the generation value 403. Moreover, the device generation value 301 in the device information 300 of the source information processing device 1 is increased by 1. As a result, the state of the source information processing device 1 is changed from the state H illustrated in FIG. 20A to a state J illustrated in FIG. 20B.

Meanwhile, the unique key 303: 111 and the device generation value 301: 1 of the source information processing device 1 are transmitted to the destination information processing device 1 by the operation flows illustrated in FIGS. 15A, 15B and 16. Then, the unique key 303: 111 and the device generation value 301: 1 of the source information processing device 1 are registered in the row of the number 1302: 3 with no registration in the source key 1303, for example, in the source management information 1300 of the destination information processing device 1. Thus, the state of the destination information processing device 1 is changed from the state I illustrated in FIG. 20A to a state K illustrated in FIG. 20B.

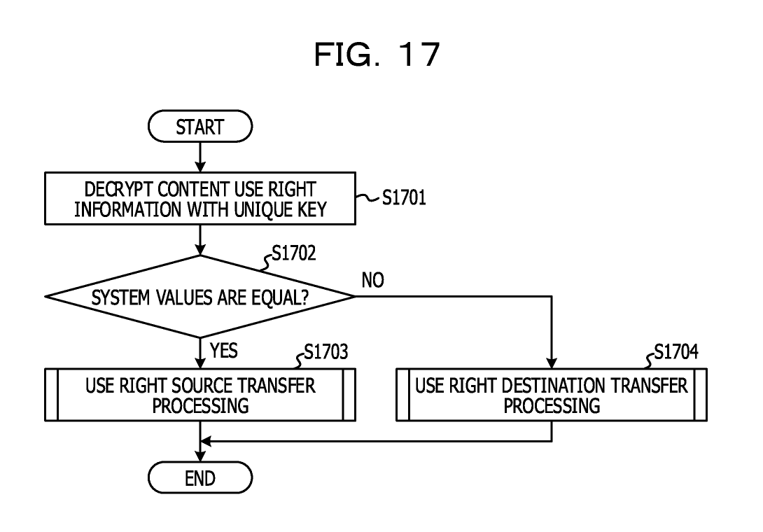

FIG. 17 is a flowchart illustrating an operation flow of content moving processing according to the second embodiment. The operation flow of the content moving processing illustrated in FIG. 17 is performed by the control unit 200 in the information processing device 1, for example, reading and executing the program 230 stored in the storage unit 220. In one embodiment, when a use instruction such as reproduction of the content is inputted to the control unit 200 in the information processing device 1, the content moving processing illustrated in FIG. 17 may be started. In another embodiment, when an instruction to move the content is inputted to the control unit 200 in the information processing device 1, the content moving processing illustrated in FIG. 17 may be started.

In S1701, the control unit 200 in the information processing device 1 uses the unique key 303 stored as the device information 300 in the storage unit 220 to decrypt the use right information 602 in the content 600. In S1702, the control unit 200 in the information processing device 1 determines whether or not the system value 606 decrypted from the use right information 602 is equal to the device system value 302 stored as the device information 300 in the storage unit 220. When the system value 606 decrypted from the use right information 602 in the content 600 is equal to the device system value 302 stored as the device information 300 in the storage unit 220 (Yes in S1702), the flow advances to S1703. Note that, in the determination in S1702, the control unit 200 in the information processing device 1 may determine, based on the system value, whether or not the use right information 602 is successfully decrypted. For example, if the system value 606 decrypted from the use right information 602 in the content 600 is equal to the device system value 302, this means that the control unit 200 has succeeded in decrypting the use right information 602. Also, here, successful decryption means that encrypted information may be correctly decrypted to the original information before execution of encryption. Meanwhile, if the system value 606 decrypted from the use right information 602 in the content 600 is different from the device system value 302, this means that an encryption key used to encrypt the use right information 602, for example, is different from an encryption key used for decryption or that the content 600 has a system value 606 of another group that is not permitted to transfer the use right, for example.

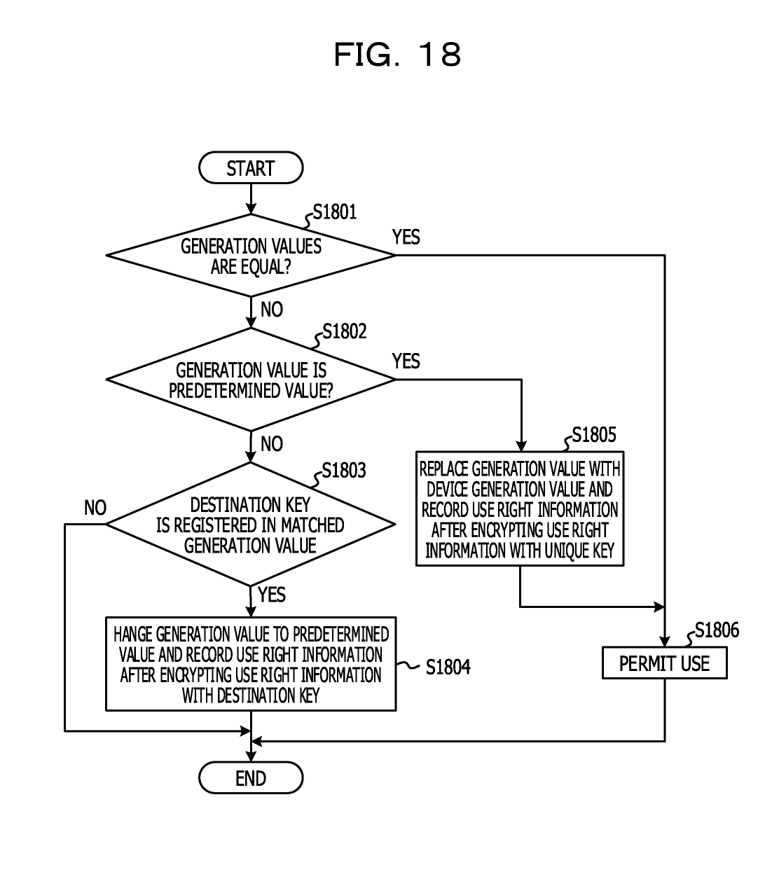

In S1703, the control unit 200 executes use right source transfer processing. FIG. 18 is a flowchart illustrating an operation flow of the use right source transfer processing according to the second embodiment. The operation flow of the use right source transfer processing of FIG. 18 is performed by the control unit 200 reading and executing the program 230 stored in the storage unit 220, for example. In one embodiment, the operation flow of FIG. 18 is started when the flow advances to S1703 in FIG. 17.

Note that processing from S1801 to S1806 in FIG. 18 may correspond to processing from S1003 to S1008 in FIG. 10, for example. Specifically, in the processing from S1801 to S1806, for example, the control unit 200 may execute the same processing as that from S1003 to S1008 in FIG. 10. For example, in S1801, the control unit 200 in the information processing device 1 may determine whether or not the generation value 605 in the use right information 602 decrypted from the content 600 is equal to the device generation value 301 registered as the device information 300 in the storage unit 220. When the operation flow of FIG. 18 is terminated, the flow returns to the operation flow of FIG. 17 and then the flow of FIG. 17 is terminated.

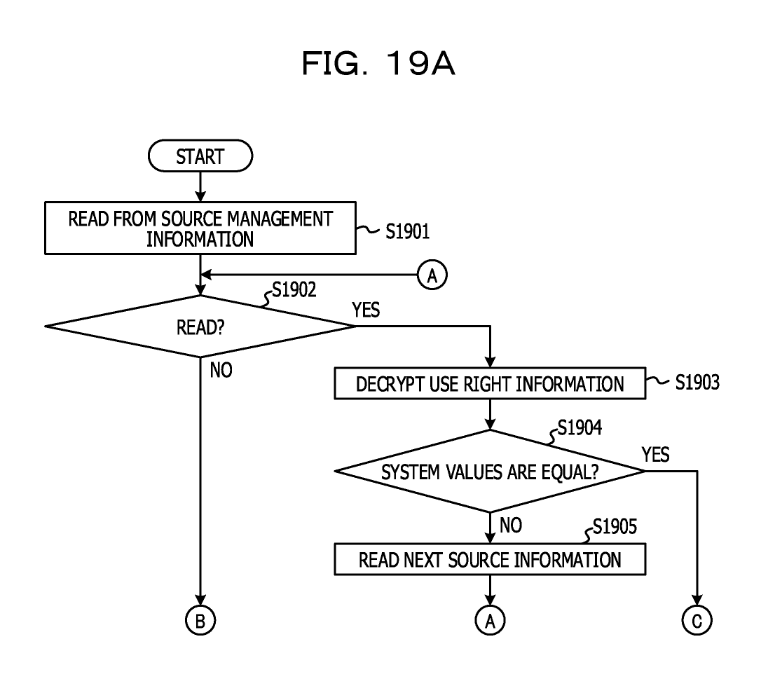

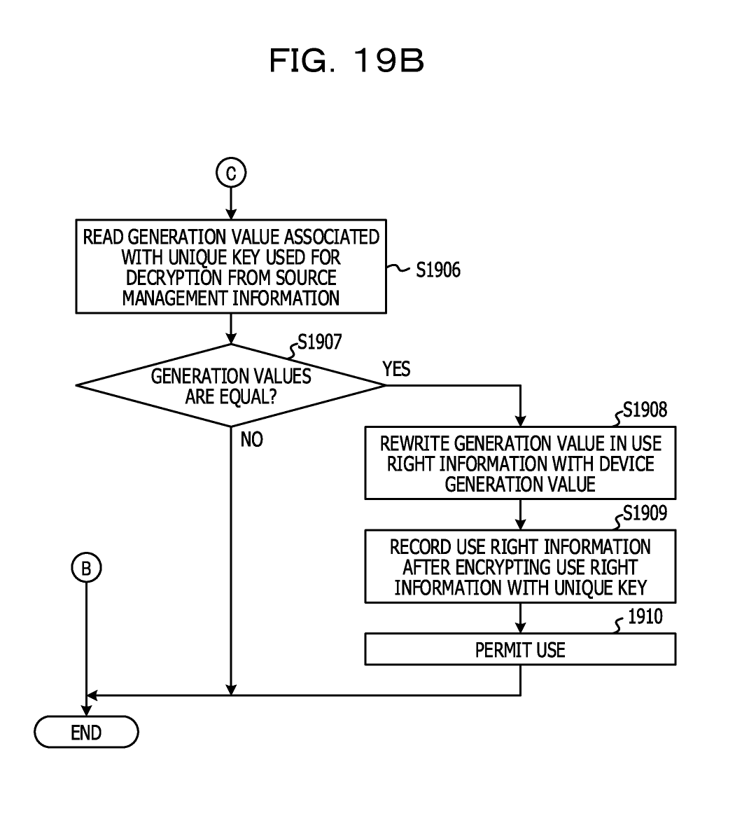

On the other hand, when the system value 606 decrypted from the use right information 602 is different from the device system value 302 stored as the device information 300 in the storage unit 220 (No in S1702), the flow advances to S1704. In S1704, the control unit 200 executes use right destination transfer processing. FIGS. 19A and 19B are flowcharts illustrating an operation flow of the use right destination transfer processing according to the second embodiment. The operation flow of the use right destination transfer processing of FIGS. 19A and 19B is performed by the control unit 200 reading and executing the program 230 stored in the storage unit 220, for example. In one embodiment, the operation flow illustrated in FIGS. 19A and 19B is started when the flow advances to S1704 in FIG. 17.

In S1901, the control unit 200 reads one piece of unselected source information 1301 from the source management information 1300. In S1902, the control unit 200 determines whether or not the unselected source information 1301 is read from the source management information 1300. When the unselected source information 1301 may not be read from the source management information 1300 (No in S1902), this operation flow is terminated. Then, the flow returns to the operation flow of FIG. 17, and the flow of FIG. 17 is terminated.

On the other hand, when the unselected source information 1301 is read from the source management information 1300 (Yes in S1902), the flow advances to S1903. In S1903, the control unit 200 decrypts the use right information 602 in the content 600 by using the unique key 303 registered in the source key 1303 in the read source information 1301. In S1904, the control unit 200 determines whether or not the system value 606 decrypted from the use right information 602 in the content 600 is equal to the device system value 302 of the information processing device 1 stored in the storage unit 220. When the device system value 302 included in the use right information 602 is different from the device system value 302 of the information processing device 1 stored in the storage unit 220 (No in S1904), the flow advances to S1905. Note that the case where the system values are different in S1904 means that the unique key 303 registered in the read source information 1301 is different from the key used to encrypt the use right information 602. Alternatively, the case where the system values are different in S1904 means that the content 600 is generated in the information processing device 1 having another device system value 302, which is different from the information processing device 1 and prohibited to transfer the use right of the content 600. In S1905, the control unit 200 reads one piece of unselected source information 1301 from the source management information 1300, and the flow returns to S1902.

On the other hand, when the system value 606 included in the use right information 602 is equal to the device system value 302 of the information processing device 1 stored in the storage unit 220 in S1904 (Yes in S1904), the flow advances to S1906. In S1906, the control unit 200 reads the generation value 1304 in the source information 1301 including the source key 1303 used to decrypt the use right information 602 in S1903. In S1907, the control unit 200 determines whether or not the generation value 1304 read from the source information 1301 is equal to the generation value 605 included in the use right information 602 of the content 600. When the generation value 1304 read from the source information 1301 is different from the generation value 605 included in the use right information 602 of the content 600 (No in S1907), this operation flow is terminated. Then, the flow returns to the operation flow of FIG. 17, and the flow of FIG. 17 is terminated.

When the generation value 1304 read from the source information 1301 is equal to the generation value 605 included in the use right information 602 of the content 600 (Yes in S1907), the flow advances to S1908. In S1908, the control unit 200 rewrites the generation value 605 in the use right information 602 with the device generation value 301 stored in the storage unit 220. In S1909, the control unit 200 generates the content 600 by encrypting the use right information 602 with the unique key 303 stored as the device information 300 in the storage unit 220, and records the generated content 600 in the storage unit 220. In S1910, the control unit 200 permits the use of the content. For example, the control unit 200 may permit content reproduction by decrypting the encrypted content 601 in the content 600 with the content encryption key decrypted from the use right information 602 in S1903. Therefore, in this case, the control unit 200 in the information processing device 1 reproduces the content 600, for example, and the user may watch or listen to the content 600. Note that the use of the content 600 is not limited to reproduction but may be display of images, programs and text data, execution of programs, and execution of backup of the content and the like. This operation flow is terminated after the control unit 200 permits the use of the content 600 in S1910. Then, the flow returns to the flow of FIG. 17, and the flow of FIG. 17 is terminated.

In the operation flows illustrated in FIGS. 17, 18, 19A and 19B described above, the control unit 200 in the information processing device 1 functions as the determination unit 211, for example, during the processing from S1701 to S1702. Also, the control unit 200 in the information processing device 1 functions as the second transfer unit 216 or the permission unit 212, for example, during the processing of S1703 and S1704. During the processing of S1801 and S1806, the control unit 200 in the information processing device 1 functions as the permission unit 212, for example. During the processing from S1802 to S1805, the control unit in the information processing device 1 functions as the second transfer unit 216, for example. During the processing from S1901 to S1909, the control unit in the information processing device 1 functions as the second transfer unit 216, for example. In the processing of S1910, the control unit 200 in the information processing device 1 functions as the permission unit 212, for example.

Next, description is given of permission to use the content and transfer of the use right of the content by the operation flows illustrated in FIGS. 17 to 19 by giving some examples of the information processing device 1 and the content 600. FIGS. 20A and 20B are diagrams illustrating some states of the information processing device 1 according to the second embodiment. As described above, FIGS. 12A to 12D illustrate some content 600 according to the embodiment.

<Case 1>

Description is given of a case where the device information 300, the destination management information 400 and the source management information 1300 of the information processing device 1 are in the state H illustrated in FIG. 20A and the operation flows illustrated in FIGS. 17 to 19 are executed for the content A illustrated in FIG. 12A. Note that the state H of the information processing device 1 illustrated in FIG. 20A is a state where the setting is performed by the setting processing illustrated in FIG. 14 described above, for example. Also, the content A illustrated in FIG. 12A is the content 600 generated when the content recording processing illustrated in FIG. 7 is executed by the information processing device 1 in the state H, for example.

In this case, in S1701 of FIG. 17, the use right information 602 of the content A is encrypted using a unique key 303: 111. Thus, in S1701, the control unit 200 in the information processing device 1 succeeds in decrypting the use right information 602 using the unique key 303: 111 in the storage unit 220. A system value 606: 1234 decrypted from the use right information 602 of the content A is equal to a device system value 302: 1234. Thus, the result of the determination in S1702 is Yes, and the control unit in the information processing device 1 executes the use right source transfer processing in S1703. Moreover, the generation value 605: 1 decrypted from the use right information 602 of the content A is equal to the device generation value 301: 1 of the information processing device 1. Thus, the result of the determination by the control unit in the information processing device 1 in S1801 is Yes, and the control unit 200 permits the use of the content A in S1806. Therefore, the control unit 200 in the information processing device 1 having the content A recorded therein by executing the recording processing may reproduce the content A. As a result, the user may watch the content A with the information processing device 1.

<Case 2>

Description is given of a case where the device information 300, the destination management information 400 and the source management information 1300 of the information processing device 1 are in the state I illustrated in FIG. 20A and the operation flows illustrated in FIGS. 17 to 19 are executed for the content A illustrated in FIG. 12A.

In this case, a unique key 303: 222 of the information processing device 1 is different from the unique key 303: 111 used to encrypt the use right information 602 of the content A. Thus, in S1701, the control unit 200 fails to decrypt the use right information 602 encrypted using the unique key 303: 111 of the content A. Then, in S1702, the device system value 302 becomes a value different from the system value 606 obtained from the use right information 602 of the content. In this case, the result of the determination in S1702 is No, and the control unit 200 in the information processing device 1 executes the use right destination transfer processing. In the processing from S1901 to S1905 in FIG. 19A, the control unit 200 in the information processing device 1 reads the source information 1301 from the source management information 1300. Then, the control unit 200 in the information processing device 1 uses the source key 1303 in the read source information 1301 to decrypt the use right information 602 of the content A, and determines whether or not the system values are equal to each other. However, the source keys 1303 “666” and “333” registered in the source management information 1300 are both different from the unique key: 111 to encrypt the use right information 602 of the content A. Thus, the result of the determination in S1904 is No, and the subsequent determination in S1902 is also No. Then, the operation flow is terminated. More specifically, the content A recorded by the information processing device 1 in the state H through the content recording processing of FIG. 7 may not be used by another information processing device 1 different from the information processing device 1 in the state H, which has executed the recording.

<Case 3>

Description is given of a case where the device information 300, the destination management information 400 and the source management information 1300 of the information processing device 1 are in the state J illustrated in FIG. 20B and the operation flows illustrated in FIGS. 17 to 19 are executed for the content A illustrated in FIG. 12A. When the use right transfer processing according to the second embodiment illustrated in FIGS. 15A, 15B and 16 is executed after the content A is recorded in the storage unit 220 in the information processing device 1 in the state H illustrated in FIG. 20A, for example, the information processing device 1 in the state H is updated to the state J illustrated in FIG. 20B.

When the operation flows illustrated in FIGS. 17 to 19 are executed for the content A by the information processing device 1 in the state J, the control unit 200 succeeds in decrypting the use right information 602 of the content A since the unique key 303 of the information processing device 1 is “111”. Also, the device system value 302 is equal to the system value of the content A in S1702, and the result of the determination in S1702 is Yes. Thus, in S1703, the control unit 200 in the information processing device 1 executes the use right source transfer processing. On the other hand, the device generation value 301: 2 of the information processing device 1 is different from the generation value 605: 1 of the use right information 602 of the content A, and is not the predetermined value. Thus, the results of the determinations by the control unit 200 in S1801 and S1802 are both No. In S1803, the destination key: 222 is registered in the destination information 401 in the destination management information 400 in the state J having a value equal to the generation value 605: 1 of the content A. Thus, the result of the determination in S1803 is Yes, and the control unit 200 changes the generation value 605 in the use right information 602 to the predetermined value: 999 and stores the content re-encrypted using the destination key 404: 222 in the storage unit 220. Note that the content stored here is the content B illustrated in FIG. 12B, for example.

As described above, even the information processing device 1 having the content A recorded therein may not reproduce the content A, when the use right transfer processing illustrated in FIGS. 15 and 16 is executed after the recording, since the device generation value 301 is updated. Moreover, in this case, the use right information 602 of the content A is rewritten into the content B to be used by the destination information processing device 1 according to the information registered in the destination information 401. Therefore, it is assumed, for example, that a backup of the content A is made in some way by the information processing device 1 and the content A is restored from the backup after execution of the transfer processing according to the first embodiment. In this case, again, the restored content A may not be reproduced by the information processing device 1 in the state J. Also, the content A is rewritten into the content B according to the information registered in the destination information 401. More specifically, even when the content may be restored by backup, restoring or the like, the number of devices having access to the content is not increased.

<Case 4>

Description is given of a case where the device information 300, the destination management information 400 and the source management information 1300 of the information processing device 1 are in the state I illustrated in FIG. 20A and the operation flows illustrated in FIGS. 17 to 19 are executed for the content B. Note that it is assumed, for example, that the source information processing device 1 in the state H executes the use right transfer processing t to the destination information processing device in the state I according to the operation flows illustrated in FIGS. 15A, 15B and 16. When the source information processing device 1 thus changed from the state H to the state J executes the operation flows illustrated in FIGS. 17 to 19, the content B is generated.

Since the information processing device 1 in the state I has the unique key 303: 222, the control unit 200 in the information processing device 1 succeeds in decrypting the use right information 602 encrypted using the unique key 303: 222 of the content B in S1701. The device system value 302 is equal to the system value 606 of the content A in S1702, and the result of the determination in S1702 is Yes. Thus, in S1703, the control unit 200 in the information processing device 1 executes the use right source transfer processing. Moreover, since the generation value of the content B is set to the predetermined value: 999, the result of the determination by the control unit 200 in the information processing device 1 is No in S1801 and Yes in S1802. Then, in S1805, the control unit 200 in the information processing device 1 replaces the predetermined value in the use right information 602 with the device generation value 301: 3 to re-encrypt the use right information 602 with the unique key 303: 222, thereby generating the content C (FIG. 12C). Subsequently, in S1806, the control unit 200 in the information processing device 1 permits the use of the content.

When the information processing device 1 in the state I executes the operation flows illustrated in FIGS. 17 to 19 again for the content C thus generated, the operation flows illustrated in FIGS. 17 to 19 proceed in the same manner as Case 1 described above, and the use of the content C is permitted in S1806. Meanwhile, even if the information processing device 1 in the state J, that is the transfer source of the use right of the content, executes the operation flows illustrated in FIGS. 17 to 19 for the content C, the control unit 200 in the information processing device 1 may not decrypt the use right information 602 with the unique key 303: 111. Thus, the operation flows illustrated in FIGS. 17 to 19 proceed in the same manner as Case 2 described above, and the content C may not be used.

<Case 5>

As a further example, description is given of a case where the device information 300, the destination management information 400 and the source management information 1300 of the information processing device 1 are in the state I illustrated in FIG. 20A and the operation flows illustrated in FIGS. 17 to 19 are executed for the content D illustrated in FIG. 12D. Note that the generation value: 20 of the content D does not are equal to the device generation value 301: 1 of the information processing device 1 in the state H, for example, and the destination key 404 corresponding to the generation value: 20 is not registered in the destination management information 400. Thus, the content D may be a content generated in an unauthorized manner.

In this case, since the unique key 303 of the information processing device 1 is “111”, the control unit 200 in the information processing device 1 succeeds in decrypting the use right information 602 encrypted with the unique key 303: 111 of the content D. Also, since the device system value 302 is equal to the system value 606 of the content D in S1702, the result of the determination in S1702 is Yes. Thus, in S1703, the control unit 200 in the information processing device 1 executes the use right source transfer processing. Subsequently, the device generation value 301 of the information processing device 1 is “1”, while the generation value of the content D is set to “20”. Thus, the results of the determinations by the control unit 200 in S1801 and S1802 are both No. Moreover, since the generation value “20” of the content D is not registered in the destination management information 400 of the information processing device 1, the result of the determination in S1803 is No, and this operation flow is terminated. Therefore, as to a content that may be generated in an unauthorized manner, for example, such as the content D, the use thereof is not permitted.

<Case 6>

Description is given of a case where the device information 300, the destination management information 400 and the source management information 1300 of the information processing device 1 are in the state K illustrated in FIG. 20B and the operation flows illustrated in FIGS. 17 to 19 are executed for the content A illustrated in FIG. 12A. Note that, when the use right transfer processing illustrated in FIGS. 15A, 15B and 16 is executed using the information processing device 1 in the state H illustrated in FIG. 20A as the source and the information processing device in the state I illustrated in FIG. 12A as the destination, for example, the destination information processing device 1 is updated to the state K illustrated in FIG. 20B.

When the information processing device 1 in the state K executes the operation flows of FIGS. 17 to 19 for the content A, the control unit 200 fails to decrypt the use right information 602 of the content A in S1702, since the unique key 303 of the information processing device 1 is “222”. Thus, the device system value 302 is different from the system value 606 of the content A in S1702, and the result of the determination in S1702 is No. In S1704, the control unit in the information processing device 1 executes the use right destination transfer processing. In the subsequent processing from S1902 to S1905 in FIG. 19A, the control unit 200 in the information processing device 1 reads the source information 1301 from the source management information 1300. Then, the control unit in the information processing device 1 uses the source key 1303 in the read source information 1301 to decrypt the use right information 602 of the content A, and determines whether or not the system values are equal to each other. Here, since the source key 1303 “111” registered in the source management information 1300 is equal to the unique key: 111 used to encrypt the use right information 602 of the content A, the result of the determination in S1904 is Yes. In S1906, the control unit 200 in the information processing device 1 reads the generation value 1304: 1 associated with the source key 1303: 111 in the source information 1301. Since the generation value 1304: 1 in the read source information 1301 is equal to the generation value 605: 1 of the content A, the result of the determination by the control unit 200 in the information processing device 1 in S1907 is Yes. Through the processing of S1908 and S1909, the control unit 200 in the information processing device 1 changes the generation value 605 of the content A to the device generation value 301: 3 of the information processing device 1 in the state K to encrypt the use right information with the unique key 303: 222, thereby generating the content C. In S1910, the control unit 200 in the information processing device 1 permits the use of the content. Therefore, the control unit 200 in the information processing device 1 in the state K may reproduce the content A, for example. As a result, the user may watch the content A with the information processing device 1 in the state K, for example.

As described above, according to the second embodiment, the use right of the content may be transferred to another device while limiting the device having the use right of the content to one device. Furthermore, as described in Case 6, for example, the use right information 602 of the content can be rewritten by the information processing device 1 that is the transfer destination of the use right of the content. Therefore, it is assumed that the destination information processing device 1 may not be used due to selling, trouble or the like after execution of the use right transfer processing according to the second embodiment illustrated in FIGS. 15A, 15B and 16, for example. In this case, again, the destination information processing device 1 may rewrite the content into a usable state.

Moreover, it is assumed that a backup of the content 600 is made in some way and the content 600 is restored from the backup after execution of the transfer processing according to the second embodiment. In this case, again, the device having the use right is limited to one device, since the right to use the restored content 600 is transferred.

Thus, a company holding the copyright of the content, for example, may feel safe to provide the content to the information processing device 1. Moreover, the user does not have to give up using the content recorded in the information processing device 1 in changing the model of the information processing device 1 or the like, for example, and may use the content with the destination information processing device 1. Furthermore, according to the second embodiment, the user does not have to bring the information processing device 1 to a place that may be trusted by a manufacturer, such as a factory, in order to transfer the use right of the content to another information processing device 1, for example. This enables reduction in time for which the user has no access to the content in transfer of the use right of the content.

Note that, in the second embodiment, the completion notification in S1511 and S1610 is used to confirm the completion of the use right transfer processing in both of the source information processing device 1 and the destination information processing device 1, and to synchronize the both devices. Thus, a situation can be reduced where the number of devices having the use right of the content is increased or decreased to zero due to incomplete use right transfer processing in one of the information processing devices 1, for example.

Moreover, as described above, the system value may be used to determine whether or not the use right information 602 of the content 600 is successfully decrypted. However, the embodiment is not limited thereto. For example, a file size, reproduction time and the like of data such as music and videos are acquired from meta-information about the data such as music and videos included in the content 600, for example, and those values may be used, instead of the system values, to determine whether or not the use right information 602 is successfully decrypted.

Furthermore, in the second embodiment, it is checked in S1508 and S1608 if the device system values 302 of the source information processing device 1 and the destination information processing device 1 are equal. Then, the use of the content is prohibited without transferring the use right of the content when the system values are different. Also, in the moving processing of the content 600, it is determined in S1702 and S1904 whether or not the system value 606 is equal to the device system value 302. Then, if the content 600 has the system value 606 of another group that is not permitted to transfer the use right, the use of the content, transfer of the use right and moving of the content are not permitted, that is, prohibited. Thus, a range within which the content 600 may be moved may be set by setting a common value among devices within a group permitted to transfer the use right of the content as the device system value 302, for example.

For example, a situation is assumed that a certain telecommunications carrier does not want their sold content 600 to be used by an information processing device 1 used through another telecommunications carrier. In this case, moving of the content 600 may be limited by setting a device system value 302 of the information processing device 1 handled by the telecommunications carrier to be different from a device system value 302 of the information processing device 1 used through the another telecommunications carrier, for example.

Alternatively, the permission to transfer the use right according to the value of the content 600 using the device system value 302 may be realized by setting different device system values 302 according to the size of the display screen of the information processing device 1, for example. For example, when a content such as a movie is reproduced by an information processing device 1 with a large screen, such as reproduction equipment connected to a projector, there is a high possibility that there are a large number of viewers. On the other hand, when a content such as a movie is reproduced by an information processing device 1 with a small screen, such as a mobile terminal, there is a high possibility that the number of viewers is one or two. Therefore, it is conceivable to change the value of the content according to the number of viewers, such as setting the price of the content higher when the content is sold to the information processing device 1 with the large screen than when the content is sold to the information processing device 1 with the small screen. In this case, the content 600 may be controlled not to be moved between devices different in sale price by setting different system values 302 for the information processing device 1 with the large screen and the information processing device 1 with the small screen, for example. As described above, grouping of a range to permit transfer of the use right based on the device system value 302 may be used for various purposes depending on the situation.

Furthermore, in the first and second embodiments described above, the information processing device 1 uses the device information 300 stored in the storage unit 220 and the use right information 602 included in the content 600 to determine whether or not the content 600 may be used. Thus, for example, the information processing device 1 does not have to manage information such as which device may reproduce the content 600, and does not have to use a storage area to manage the content 600. After transfer of the use right of the content 600, the original content 600 may be deleted from the source information processing device 1. Therefore, the limitation on the number of contents that may be handled by the information processing device 1 is reduced. Moreover, the content 600 does not have to carry a list of information processing devices 1 having access to the content, for example. Therefore, a data amount of the content 600 is not increased even when the transfer of the use right of the content 600 is repeated, for example. Furthermore, in the first and second embodiments described above, management by a server or the like does not have to be used to limit the use of the content to one and only one device. Therefore, the information processing device 1 may transfer the use right to another device while limiting the use of the content to one and only one device, even in an environment where the information processing device 1 may not connect to a network or even when the information processing device 1 does not have a function to connect to the network.

Furthermore, in the first and second embodiments described above, the source information processing device 1 after executing the transfer of the use right of the content may record the content using a new device generation value 301 updated by the use right transfer processing, for example. In this case, the updated new device generation value 301 is registered in the use right information 602 of the newly recorded content 600. Thus, the content 600 is bound to the source information processing device 1. Therefore, the source information processing device 1 may be reused after the transfer of the use right of the content is executed, for example. Moreover, the information processing device 1 having the use right may be repeatedly changed by repeating the use right transfer processing for the content 600. Note that, in the first and second embodiments, for example every time the use right transfer processing is executed, the device generation value 301 is updated to a value that is different from the value that has already been set as the device generation value 301 and also is different from the predetermined value. Thus, the use of the content may be permitted while limiting the use of the content to one and only one device even when the transfer of the use right of the content 600 is repeated.

Although some embodiment are described above, the embodiments are not limited to those described above. For example, in the above embodiments, the description is given of the case where the secret key and the public key are used to hand over the unique key in the examples of FIGS. 8, 9, 15A, 15B and 16. However, the embodiments are not limited thereto. For example, a common encryption key may be used to hand over the unique key. Likewise, in the above embodiments, the description is given of the case where the unique key 303 unique to the information processing device 1 is the common encryption key. However, the embodiments are not limited thereto, but a relative key pair may be used. Furthermore, the unique key 303 unique to the information processing device 1 may be generated every time encryption processing is performed or may be used by reading a key previously generated when performing the encryption processing.

Moreover, the operation flows of FIGS. 5, 7, 8, 9, 10, 14, 15A, 15B, 16, 17, 18, 19A and 19B described above, for example, are examples, and the embodiments are not limited thereto. For example, the processing order may be changed, if possible, or may further include another processing. Alternatively, some of the processing may be omitted. For example, in another embodiment, the processing from S501 to S503 may be executed by arbitrarily replacing the order. Likewise, the processing from S501 to S503 may be executed by arbitrarily replacing the order.

The order of the processing of S807 and S808 may be replaced as long as the processing of registering the unique key as the destination key 404 in S807 is executed such that the unique key is registered in the destination information 401 having the device generation value 301 before updating of the device generation value 301 in S808, as the generation value 403. Likewise, the order of the processing of S1509 and S1510 may be replaced as long as the registration processing in S1509 is executed such that the unique key is registered in the destination information 401 having the device generation value 301 before updating of the device generation value 301 in S1510, as the generation value 403.

Moreover, in the first and second embodiments described above, the description is given of the case where the values set as the device generation value 301 are registered beforehand sequentially from the initial value. However, the embodiments are not limited thereto. For example, in a modified example of the first and second embodiments, the control unit 200 may empty the entire column of the generation value 403 in S505 and S1403. Also, in this case, the control unit 200 may register the device generation value 301 read from the storage unit 220 in the empty space of the destination information 401 while associating the device generation value 301 with the unique key 303 of the destination information processing device 1, which is decrypted in S806 and S1506.

Furthermore, as a modified example of the second embodiment, for example, the flow may be returned to S1902 when the result of the determination in S1907 is No. Accordingly, moving of the content may be executed when the content moving processing from the same source information processing device 1 is executed several times, for example.

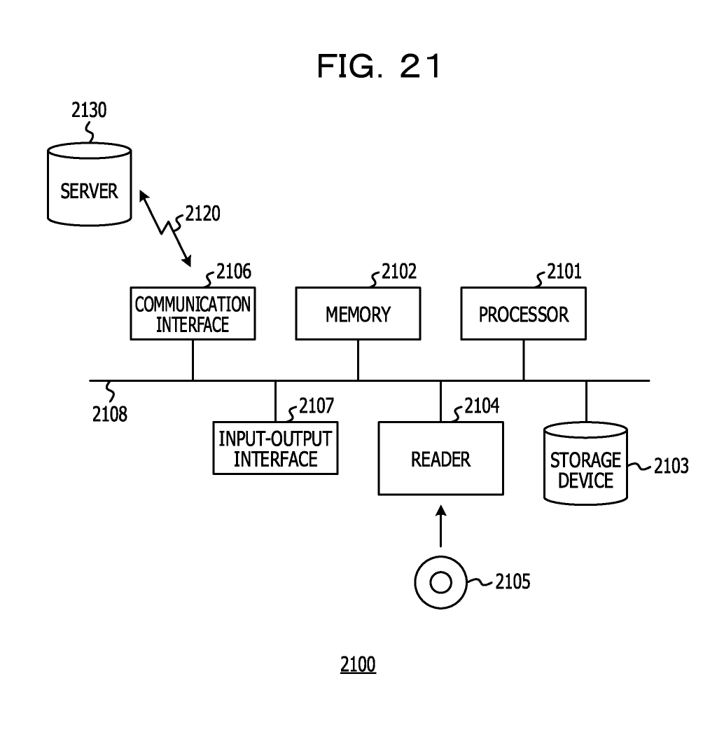

FIG. 21 is a diagram illustrating a hardware configuration of a computer 2100 to realize the information processing device 1 according to one embodiment. The computer 2100 illustrated in FIG. 21 includes a processor 2101, a memory 2102, a storage device 2103, a reader 2104, a communication interface 2106 and an input-output interface 2107, for example. Note that the processor 2101, the memory 2102, the storage device 2103, the reader 2104, the communication interface 2106 and the input-output interface 2107 are connected to each other through a bus 2108, for example.

The processor 2101 provides some of or all of the functional units described above by executing the program 230 describing the procedures of the operation flows described above, for example, using the memory 2102. For example, the control unit 200 in the information processing device 1 is the processor 2101, and the storage unit 220 includes the memory 2102, the storage device 2103 and a detachable storage medium 2105, for example. The processor 2101 may function as the setting unit 210, the determination unit 211, the permission unit 212, the update unit 213, the registration unit 214, the first transfer unit 215, the second transfer unit 216 and the saving unit 217 by reading and executing the program 230 from the storage device 2103, for example. The storage device 2103 may store information such as the device information 300, the destination management information 400 and the source management information 1300, for example. The detachable storage medium 2105 in the information processing device 1 may store the content 600, for example.

The memory 2102 is a semiconductor memory, for example, and includes a RAM region and a ROM region. Note that RAM stands for Random Access Memory. ROM stands for Read Only Memory. The storage device 2103 is a hard disk, a semiconductor memory such as a flash memory or an external storage device, for example.

The reader 2104 accesses the detachable storage medium 2105 according to an instruction from the processor 2101. The detachable storage medium 2105 is realized by a semiconductor device (USB memory, SD memory card and the like), a medium (magnetic disk or the like) to input and output information by magnetic action, a medium (CD-ROM, DVD and the like) to input and output information by optical action, or the like, for example. Note that USB stands for Universal Serial Bus. CD stands for Compact Disc. DVD stands for Digital Versatile Disk.

The communication interface 2106 may be a communication device such as a radio LAN communication device, an NFC communication device and an infrared communication device, for example. Note that LAN stands for Local Area Network. The communication interface 2106 may transmit and receive data through a network 2120 according to an instruction from the processor 2101 for example. The communication interface 2106 may also transmit and receive data by connecting to another information processing device 1 according to an instruction from the processor 2101, for example. The input-output interface 2107 is an interface between an input device and an output device, for example. The input device may be an input key to receive an instruction from the user and a device such as a touch panel, for example. The output device may be a display device such as a display and an audio device such as a speaker, for example.

Each of the programs according to the embodiments are provided to the information processing device 1 in the following manner, for example.

(1) Pre-installed in the storage device 2103

(2) Provided by the detachable storage medium 2105

(3) Provided from a server 2130 such as a program server

It is understood by those skilled in the art that some embodiments including the embodiments described above include various modifications of and alternatives to the embodiments described above. For example, various embodiments may be embodied by modifying the constituent elements. Moreover, various embodiments may be implemented by appropriately combining the constituent elements disclosed in the embodiments described above. Furthermore, various embodiments may be implemented by deleting or replacing some of the constituent elements disclosed in the embodiments or by adding some constituent elements to the constituent elements disclosed in the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control method executed by a processor included in a first information processing device, the control method comprising:
acquiring, from a storage medium, content data and first encrypted information encrypted by a first unique key associated with the first information processing device, the first encrypted information including a first value for controlling a use right of the content data;
obtaining the first value by decrypting the first encrypted information with the first unique key;
enabling the first information processing device to use the content data when the first value is identified with a second value allocated to the first information processing device;
generating second encrypted information by encrypting a third value with a second unique key that is associated with the second information processing device, the third value being for moving the use right from the first information processing device to the second information processing device; and
updating the first encrypted information in the storage medium with the second encrypted information.

2. The control method according to claim 1, wherein
the storage medium is a removable storage medium,
the content data and the first encrypted information are acquired from the removable storage medium, and
the content data and the second encrypted information are stored into the removable storage medium.

3. The control method according to claim 1, wherein the generating is executed in response to the first information processing device receiving an instruction for moving the use right of the content data from the first information processing device to the second information processing device.

4. The control method according to claim 1, wherein the third value is a predetermined value which is used commonly among a device group including the first information processing device and the second information processing device.

5. The control method according to claim 4, further comprising:
determining whether the first value is identified with the predetermined value when the first value is not identified with the second value;
enabling the first information processing device to use the content data when the first value is identified with the predetermined value; and
updating the predetermined value to the first value.

6. The control method according to claim 1, further comprising:
receiving the second unique key from the second information processing device in advance;
storing the second unique key associated with the second value allocated to the first information processing device; and
updating the second value to a new value which is used for identifying the first information processing device.

7. The control method according to claim 1, further comprising:
generating first information when the content data is received from a server, the first information including the first value stored in the memory; and
encrypting the first information with the first unique key to generate the first encrypted information.

8. The control method according to claim 1, wherein
the content data is encrypted by a content key, and
the first encrypted information and the second encrypted information further include the content key.

9. The control method according to claim 1, wherein the enabling includes enabling the first processing device to reproduce a content corresponding to the content data which is granted a copyright, when the first value is identified with the second.

10. A system comprising:
a circuitry configured to:
acquire, from a storage medium, content data and first encrypted information encrypted by a first unique key associated with a first information processing device, the first encrypted information including a first value for controlling a use right of the content data,
obtain the first value by decrypting the first encrypted information with the first unique key,
enable the first information processing device to use the content data when the first value is identified with a second value allocated to the first information processing device,
generate second encrypted information by encrypting a third value with a second unique key that is associated with the second information processing device, the third value being for moving the use right from the first information processing device to the second information processing device, and
update the first encrypted information in the storage medium with the second encrypted information.

11. The system according to claim 10, wherein
the storage medium is a removable storage medium,
the content data and the first encrypted information are acquired from the removable storage medium, and
the content data the second encrypted information are stored into the removable storage medium.

12. The system according to claim 10, wherein the circuitry is configured to receive an instruction for moving the use right of the content data from the first information processing device to the second information processing device.

13. The system according to claim 10, wherein the third value is a predetermined value which is used commonly among a device group including the first information processing device and the second information processing device.

14. The system according to claim 13, wherein the circuitry is configured to:
determine whether the first value is identified with the predetermined value when the first value is not identified with the second value,
enable the first information processing device to use the content data when the first value is identified with the predetermined value, and
update the predetermined value to the first value.

15. The system according to claim 10, wherein the circuitry is configured to:
receive the second unique key from the second information processing device in advance,
store the second unique key associated with the second value allocated to the first information processing device, and
update the second value to a new value which is used for identifying the first information processing device.

16. The system according to claim 10, wherein the circuitry is configured to:
generate first information when the content data is received from a server, the first information including the first value stored in the memory, and
encrypt the first information with the first unique key to generate the first encrypted information.

17. The system according to claim 10, wherein
the content data is encrypted by a content key, and
the first encrypted information and the second encrypted information further include the content key.

18. The system according to claim 10, wherein the circuitry is configured to reproduce a content corresponding to the content data which is granted a copyright, when the first value is identified with the second.

19. A non-transitory computer-readable storage medium storing a program which, when executed by a first information processing device, causes the first information processing device to:
acquire, from a storage medium, content data and first encrypted information encrypted by a first unique key associated with the first information processing device, the first encrypted information including a first value for controlling a use right of the content data;
obtain the first value by decrypting the first encrypted information with the first unique key;
enable to use the content data when the first value is identified with a second value allocated to the first information processing device;
generate second encrypted information by encrypting a third value with a second unique key that is associated with the second information processing device, the third value being for moving the use right from the first information processing device to the second information processing device; and
update the first encrypted information in the storage medium with the second encrypted information.
